(19) United States
(12) Patent Application Publication
(10) Pub. No.: US 2019/0004698 A1
(43) Pub. Date: Jan. 3, 2019

(54) VIRTUAL TOOLS FOR USE WITH TOUCH-SENSITIVE SURFACES

(71) Applicant: Carnegie Mellon University, Pittsburgh, PA (US)

(72) Inventors: Christopher Harrison, Pittsburgh, PA (US); Li Li, Cupertino, CA (US); Jason Liang, San Francisco, CA (US); Taihei Munemoto, Pittsburgh, PA (US)

(21) Appl. No.: 16/126,175

(22) Filed: Sep. 10, 2018

Related U.S. Application Data
(63) Continuation-in-part of application No. 13/863,193, filed on Apr. 15, 2013, now Pat. No. 10,082,935.

(51) Int. Cl. G06F 3/0488; G06F 3/041

(52) U.S. Cl. CPC G06F 3/04886; G06F 3/0416; G06F 3/044; G06F 2203/04808; G06F 2203/04104

(57) ABSTRACT

An electronic device includes a touch-sensitive surface, for example a touch pad or touch screen. The user interacts with the touch-sensitive surface, producing touch interactions. Some of these touch interactions may be detected as indicative of a grasp for manipulating a physical tool (e.g., the grasp for holding a pen). When these touch interactions are encountered, a corresponding virtual tool is instantiated. The virtual tool controls an action on the electronic device that is similar to an action that can be performed by the physical tool. For example, the virtual pen can be used to draw on the display, whereas the physical pen draws on paper. A representation of the virtual tool is also displayed on a display for the electronic device, possibly providing additional affordances, at a location that corresponds to a location of the detected touch interaction.

### CROSS-REFERENCE TO RELATED APPLICATIONS

This application is a continuation-in-part application of U.S. patent application Ser. No. 13/863,193, filed on Apr. 15, 2013, entitled “VIRTUAL TOOLS FOR USE WITH TOUCH-SENSITIVE SURFACES,” which is hereby incorporated by reference as if fully set forth herein.

### TECHNICAL FIELD

This invention relates generally to interacting with electronic devices, for example via a touch-sensitive surface.

### BACKGROUND

Many touch pads and touch screens today are able to support a small set of gestures. For example, one finger is typically used to manipulate a cursor or to scroll the display. Another example is using two fingers in a pinching manner to zoom in and out of content, such as a photograph or map. However, this is a gross simplification of what fingers and hands are capable of doing. Fingers are diverse appendages, both in their motor capabilities and their anatomical composition. Furthermore, fingers and hands can also be used to manipulate tools, in addition to making gestures themselves.

Thus, there is a need for better utilization of the capabilities of fingers and hands to control interactions with electronic devices.

### SUMMARY

The present invention allows users to instantiate and manipulate virtual tools in a manner similar to how they grasp and manipulate the corresponding physical tools.

In one aspect, an electronic device includes a touch-sensitive surface, for example a touch pad (which does not also function as a display) or touch screen (which does also function as a display). The user interacts with the touch-sensitive surface, producing touch interactions. Some of these touch interactions may be detected as indicative of a grasp for manipulating a physical tool (e.g., the grasp for holding a pen). When these touch interactions are encountered, a corresponding virtual tool is instantiated. The virtual tool controls an action on the electronic device that is similar to an action that can be performed by the physical tool in the real world. For example, the virtual pen can be used to draw on the display, whereas the physical pen draws on paper. An image (or other representation) of the virtual tool is also displayed on a display for the electronic device, at a location that corresponds to a location of the detected touch interaction.

The action can be controlled by the virtual tool in different ways. For some virtual tools, detecting the correct touch interaction and instantiating the virtual tool may also initiate a corresponding action. For example, a virtual magnifying glass may immediately magnify an area of the display upon instantiation. For other virtual tools, additional actions may be required to specify actions. For example, a virtual pen may require subsequent translation of the touch interaction in order to draw a line on the display. As another example, a virtual camera may require a subsequent motion mimicking pressing a shutter button in order to capture an image. The virtual tool may also move, rotate and/or change in response to these subsequent actions.

In one approach, touch interactions are classified based on patterns of individual touch contacts. For example, virtual tools may be assigned only to those touch interactions that have three or more simultaneous touch contacts, leaving single-touch and two-touch patterns for existing functions such as scroll or zoom. These more complex touch contact patterns can be classified based on the number of touch contacts, as well as features such as position, shape, size and/or orientation of the touch contacts, both individually and as a whole.

In another aspect, the type of touch contacts reported by a touch-sensitive surface may vary. In some systems, a touch screen might report a series of touch points (e.g., x/y locations, sometimes with major and minor axes). Other touch screens might provide a two-dimensional image of capacitance, infrared reflectance, z-distance, or other sensing approaches. We use the term “touch contacts” generically to cover all types of touch technologies and capabilities.

Examples of virtual tools include the following. Virtual pen, pencil, paint brush, highlighter and other writing instruments may be used for drawing lines, digital painting, highlighting and other similar actions. Different types of virtual erasers may be used for erasing. Virtual ruler, tape measure and other distance measuring instruments may be used for functions related to lengths or distances. Virtual scissors, knife and other cutting tools may be used for digital cutting. Virtual camera may be used for image capture. Virtual magnifier may be used for image zoom. Virtual tweezers and other grasping instruments may be used for digital grabbing. Further examples of virtual tools can include, without limitation, a virtual mouse, a virtual dial, a virtual wheel, a virtual turn knob, a virtual slider control, and so on.

Other aspects of the invention include methods, devices, systems, components and applications related to the approaches described above.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a block diagram of an electronic device according to the present invention.

FIG. 2 is a flow diagram illustrating touch interaction using the device of FIG. 1.

FIG. 3 is a flow diagram illustrating one approach to analyzing touch interactions.

FIGS. 4A-4D illustrate use of a physical pen, use of a virtual pen, and two touch contact patterns for the virtual pen, respectively.

FIGS. 5A-5C illustrate use of a physical eraser, use of a virtual eraser, and a touch contact pattern for the virtual eraser, respectively.

FIGS. 5D-5E illustrate use of a smaller virtual eraser, and a touch contact pattern for the smaller virtual eraser, respectively.

FIGS. 6A-6C illustrate use of a physical magnifier, use of a virtual magnifier, and a touch contact pattern for the virtual magnifier, respectively.

FIGS. 7A-7C illustrate use of a physical camera, use of a virtual camera, and a touch contact pattern for the virtual camera, respectively.

FIGS. 8A-8C illustrate use of a physical tape measure, use of a virtual tape measure, and a touch contact pattern for the virtual tape measure, respectively.

FIG. 9 illustrates an exemplary flow diagram of methods directed to classifying touch interactions as indicative of a particular physical tool and further aspects of non-limiting aspects of the disclosed subject matter in accordance with the embodiments described herein;

FIG. 10 depicts an exemplary operating environment in which various non-limiting embodiments as described herein can be practiced;

FIG. 11 depicts a non-limiting example of classifying touch interactions as indicative of a particular physical tool according to non-limiting aspects as described herein;

FIG. 12 depicts another non-limiting example of classifying touch interactions as indicative of a particular physical tool according to further non-limiting aspects as described herein;

FIG. 13 depicts a further non-limiting example of classifying touch interactions as indicative of a particular physical tool according to non-limiting aspects as described herein;

FIG. 14 depicts a non-limiting example of classifying touch interactions as indicative of a particular physical tool according to non-limiting aspects as further described herein;

FIG. 15 depicts a further non-limiting example of classifying touch interactions as indicative of a particular physical tool according to further non-limiting aspects as described herein;

FIG. 16 depicts another non-limiting example of classifying touch interactions as indicative of a particular physical tool according to further non-limiting aspects as described herein;

FIG. 17 depicts a further non-limiting example of classifying touch interactions as indicative of a particular physical tool according to other non-limiting aspects as described herein;

FIG. 18 depicts an exemplary non-limiting device or system suitable for performing various aspects of the disclosed subject matter;

FIG. 19 is a block diagram representing exemplary non-limiting networked environments in which various embodiments described herein can be implemented;

FIG. 20 is a block diagram representing an exemplary non-limiting computing system or operating environment in which one or more aspects of various embodiments described herein can be implemented; and

FIG. 21 illustrates a schematic diagram of an exemplary mobile device (e.g., a mobile handset) that can facilitate various non-limiting aspects of the disclosed subject matter in accordance with the embodiments described herein.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

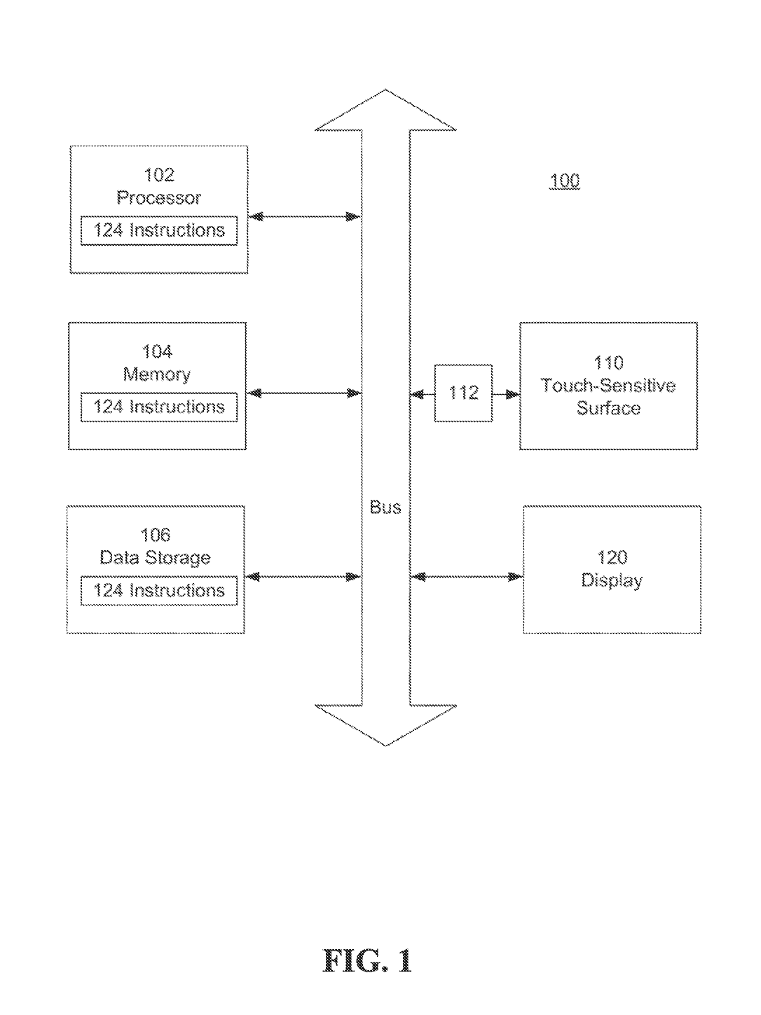

FIG. 1 is a block diagram of an electronic device 100 according to the present invention. The device 100 includes a touch-sensitive surface 110, for example a touch pad or touch screen. It also includes computing resources, such as processor 102, memory 104 and data storage 106 (e.g., an optical drive, a magnetic media hard drive or a solid state drive). Detection circuitry 112 provides an interface between the touch-sensitive surface 110 and the rest of the device 100. Instructions 124 (e.g., software), when executed by the processor 102, cause the device to perform certain functions. In this example, instructions 124 include a touch analysis module that analyzes the user interactions with the touch-sensitive surface 110. The instructions 124 also allow the processor 102 to control a display 120 and to perform other actions on the electronic device.

In a common architecture, the data storage 106 includes a machine-readable medium which stores the main body of instructions 124 (e.g., software). The instructions 124 may also reside, completely or at least partially, within the memory 104 or within the processor 102 (e.g., within a processor's cache memory) during execution. The memory 104 and the processor 102 also constitute machine-readable media.

In this example, the different components communicate using a common bus, although other communication mechanisms could be used. As one example, the processor 102 could act as a hub with direct access or control over each of the other components.

The device 100 may be a server computer, a client computer, a personal computer (PC), tablet computer, handheld mobile device, or any device capable of executing instructions 124 (sequential or otherwise) that specify actions to be taken by that device. Further, while only a single device is illustrated, the term “device” shall also be taken to include any collection of devices that individually or jointly execute instructions 124 to perform any one or more of the methodologies discussed herein. The same is true for each of the individual components. For example, the processor 102 may be a multicore processor, or multiple processors working in a coordinated fashion. It may also be or include a central processing unit (CPU), a graphics processing unit (GPU), a network processing unit (NPU), a digital signal processor (DSP), one or more application specific integrated circuits (ASICs), or combinations of the foregoing. The memory 104 and data storage 106 may be dedicated to individual processors, shared by many processors, or a single processor may be served by many memories and data storage.

As one example, the device 100 could be a self-contained mobile device, such as a cell phone or tablet computer with a touch screen. In that case, the touch screen serves as both the touch-sensitive surface 110 and the display 120. As another example, the device 100 could be implemented in a distributed fashion over a network. The processor 102 could be part of a cloud-based offering (e.g., renting processor time from a cloud offering), the data storage 106 could be network attached storage or other distributed or shared data storage, and the memory 104 could similarly be distributed or shared. The touch-sensitive surface 110 and display 120 could be user I/O devices to allow the user to interact with the different networked components.

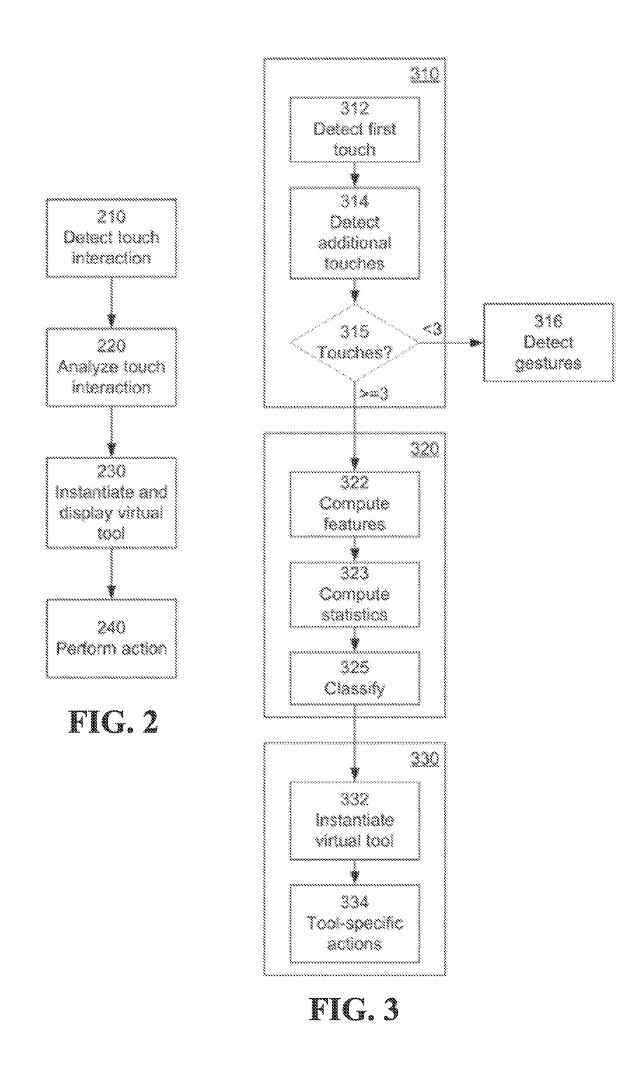

FIG. 2 is a flow diagram illustrating touch interaction using device 100. The user interacts with the touch-sensitive surface 110, for example his hand(s) may form certain poses which are meant to instruct the electronic device to perform corresponding actions. The touch-sensitive surface 110 and detection circuitry 112 detect 210 this touch interaction. For example, the touch-sensitive display may be based on resistive, capacitive, optical, acoustic (e.g., surface acoustic wave), force sensing materials (e.g., pressure, shear), piezo material, or other technologies that form the underlying basis for the touch interaction. Whatever the underlying principle of operation, touches on the touch-sensitive surface will result in signals. However, these raw signals typically are not directly usable in a digital computing environment. For example, the signals may be analog in nature. The detection circuitry 112 typically provides an intermediate stage to process and/or condition these signals so that they are suitable for use in a digital computing environment.

A touch analysis module (implemented by instructions 124 in this example) analyzes 220 the detected touch interaction as an initial step to determine the appropriate actions to take. In this example, the analysis determines whether the touch interaction is indicative of a grasp for manipulating a physical tool. If it is, then the electronic device 100 instantiates a corresponding virtual tool that controls an action similar to an action that may be taken by the physical tool. For example, the user may form his hand into the shape for grasping a physical pen, which is intended to instruct the device 100 to instantiate a virtual pen to draw on the display 120. As another example, the user may form two hands into the shape for grasping and operating a physical camera, which is intended to instruct the device 100 to instantiate a virtual camera to take a screen shot or to operate a physical camera within the device. The touch analysis module 124 determines which of these virtual tools, if any, are indicated by the detected touch interaction.

Based on this analysis, the processor 102 then takes the appropriate actions. It instantiates 230 the corresponding virtual tool and causes an image (or other representation) of the virtual tool to be displayed 230 on the display 120. It also causes any corresponding actions to be performed 240. In the pen example, when the pen grasp is identified 220, then a virtual pen is instantiated and an image of a virtual pen is displayed 230. The user further manipulates the virtual tool (e.g., the virtual pen may move around on the display 120 as the user's grasp moves around on the touch-sensitive surface 110), and the corresponding action of drawing a line also takes place 240. In the camera example, when the camera grasp is identified 220, then the virtual camera is instantiated and an image of a camera (or a viewfinder, or other image representing the virtual camera) is displayed. The virtual camera may be further manipulated, and the corresponding action of screen capture also takes place 240. Note the correspondence between the physical world and the virtual world. In the physical world, the user makes a grasp appropriate for handling a physical tool. This grasp is detected through the touch-sensitive surface. The corresponding virtual tool is instantiated and displayed, and the electronic device takes actions that are similar to actions that could be performed by the physical tool.

FIG. 3 is a flow diagram illustrating one approach to analyzing touch interactions. This approach has been successfully implemented on an iPad tablet computer running iOS. The software was implemented in Objective-C++ using the OpenFrameworks application framework. At a high level, this implementation captures 310 the user's touches, classifies 320 the touches using a machine-learning classifier, and then instantiates 330 the user's requested virtual tool.

To capture 310 the user's touch interaction, the system detects 312 a first user touch on the touch screen and then waits 314 thirty milliseconds for additional touches. The system captures 314 the touch contacts reported by the touch screen up to that point, and the touches for these contacts are considered to be simultaneous. The delay allows the touch screen to have enough time to report all touch contacts, while avoiding excessive latency in instantiating the virtual tool. Other wait times are possible. In this particular example, all virtual tools require three or more simultaneous touches. Therefore, if 315 there are two or fewer touches in the captured set, no further classification with respect to virtual tools is needed 316. One-touch or two-touch interactions may be further interpreted as starting a traditional action, such as tap, pan, pinch-to-zoom, or rotation. This approach means virtual tools can be added as extra functionality for those who have prior experience with one- and two-touch gestures.

Otherwise, the system proceeds to classify 320 the tool based on the touch contact pattern formed by the individual touches or touch contacts. In this particular implementation, the system computes 322 a set of features that are a function of the pattern of touch contacts (referred to as the touch contact pattern) and also the x-y positions and the sizes of the individual touch contacts. In this example, the feature set was chosen specifically to be rotation invariant, so that the virtual tools can be instantiated at any angle. This exemplary feature set includes the number of touch contacts, the total touch area of the touch contact pattern (i.e., total area for all touch contacts), and the magnitude of the first and second principle components of the touch contact pattern (i.e., the lengths of the major and minor axes of the touch contact pattern). This exemplary feature set also computes 323 statistical quantities (mean, median, min, max, standard deviation) over four sets of data: distances between each pair of touch contacts, distance from each individual touch point to the centroid of the touch contact pattern, angles between consecutively-clockwise touches as measured from the centroid of the touch contact pattern, and the size of each touch contact.

This is just one example. Other features and/or statistics could be computed. For example, if a two-dimensional image of the touch contact pattern is available, an exemplary feature set could include a contour analysis, a histogram of oriented gradients (which counts occurrences of different gradient orientations), first and second principle components of the touch contacts in the touch image (e.g., scale-invariant feature transform), and/or Haar-like features.

The computed feature set 322 and statistical quantities 323 are used as input to a quadratic (non-linear) support vector machine classifier 325, which has been trained on previously recorded data. Other classifiers are possible, including decision trees, naive Bayes, and neural networks. In other non-limiting implementations, exemplary classifiers can comprise algorithms including but not limited to k-nearest neighbors, logistic regression, AdaBoost-based, and random forest, and in a further non-limiting aspect can aggregate results from any number of classifiers to enhance the quality of overall decision making. The virtual tool indicated by the classifier 325 is then instantiated 332, making it visible on screen and enabling tool-specific actions 334.

The process shown in FIG. 3 is just one example. Other approaches will be apparent. For example, different features of combinations of features may be used to classify touch interactions. Individual touches may be characterized by size, shape, position, orientation, pressure, temporal duration, and/or contacting part (finger tip, finger nail, finger pad, knuckle, thumb, etc.). These quantities may be absolute or relative. For example, the size of a touch may be the absolute physical size of the touch contact, or the relative size compared to other touches in the touch interaction. As another example, the position may be the absolute position on the touch-sensitive surface, or the relative position within the overall touch contact pattern. Similar possibilities apply to features for the overall touch contact pattern. Temporal information, such as changes in the touch interaction over time, may also be used. Furthermore, information gathered from other sources may also be used to help classify the touch interaction, for example historical data about touch interactions or device usage.

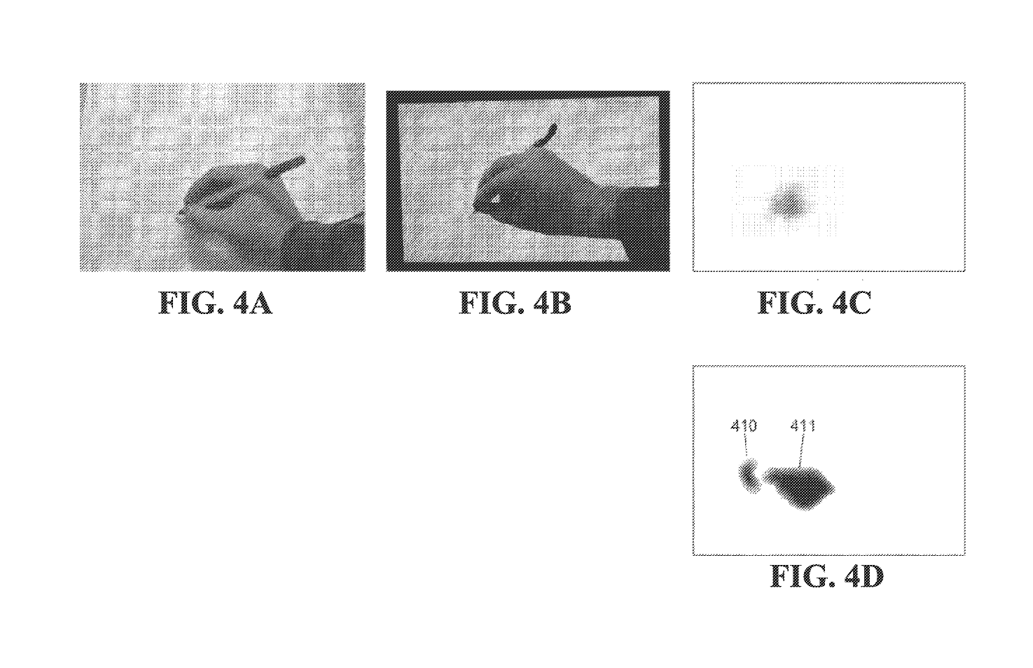

FIGS. 4-8 illustrate different examples of virtual tools. Each figure has three parts A-C. Part A shows a hand grasping a physical tool. Part B shows a hand “grasping” the corresponding virtual tool. Part C shows an example touch contact (a simulated two-dimensional capacitive or pressure image) produced by the hand grasp of Part B.

FIG. 4A shows a hand grasping a pen (or other writing instrument). FIG. 4B shows a touch screen displaying a virtual pen, with a hand “grasping” the virtual pen. The pen has just been instantiated on the touch screen. As the user moves his grasp, the virtual pen will draw onto content displayed on the touch screen. Note that the hand grasp is not exactly the same in FIGS. 4A and 4B. The grasp in FIG. 4B is more similar to a hand grasping a pen that is lying on top of the touch screen. FIG. 4C shows an example touch contact pattern (a simulated two-dimensional capacitive image) produced by the fingers of the hand grasp of FIG. 4B. In another example shown in FIG. 4D, touch contact 410 and touch contact 411 is a combination of the thumb, fingers, palm and other parts of the hand. Many other touch contacts are possible, possibly user specific, but all are exemplary of hand grasps of tools.

Note that, in one approach, the hand grasp is not required to be one specific grasp. Many different types of hand grasps may be classified as instantiating a virtual pen, for example. FIGS. 4C and 4D show different touch contacts produced by different hand grasps, but both of which are classified as instantiating a virtual pen. In this approach, users are not required to perform the same grasp exactly the same each time, or even the same grasp as other people. In one approach, a classifier supports different types of hand grasps. These may be several recognized ways to grasp a pencil for example. The classifier learns the different grasps.

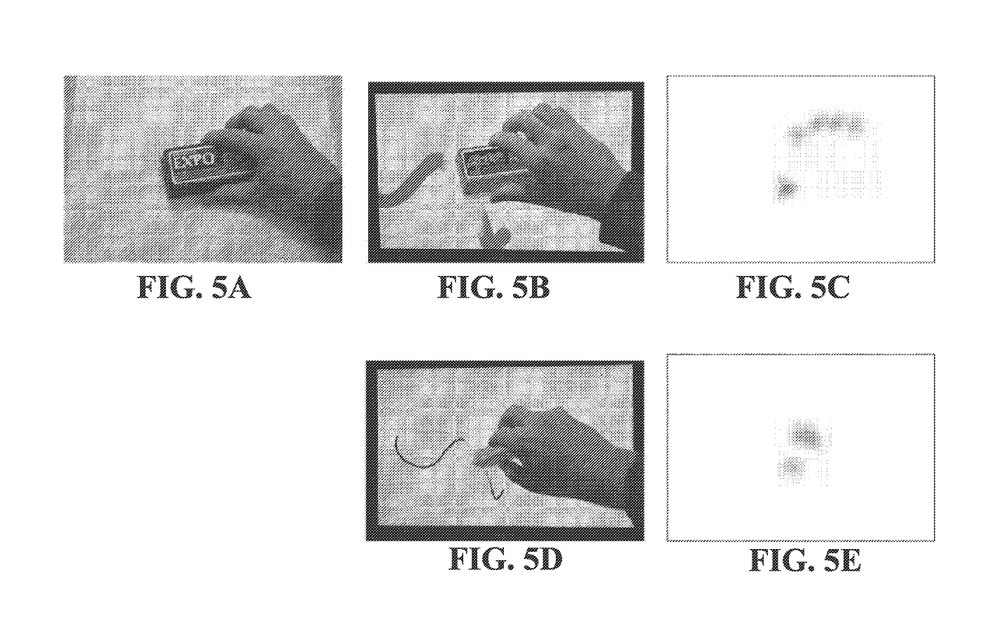

FIG. 5 shows an example using a large eraser. FIG. 5A shows grasping a physical eraser, FIG. 5B shows grasping the virtual eraser that is erasing a broad swath. FIG. 5C is the corresponding touch contact pattern (a simulated two-dimensional capacitive image). Compare this to FIGS. 5D-5E. FIG. 5D shows grasping a smaller virtual eraser that erases a narrower swath, and FIG. 5E shows the corresponding touch contact pattern. The two erasers can be distinguished by different touch contact patterns. The touch contact pattern in FIG. 5C shows a thumb and four fingers while the touch contact pattern in FIG. 5E shows a thumb and only two fingers. Note also that the touch contact pattern in FIG. 5E can be distinguished by the classifier from that in FIG. 4C due to the different spacing between the thumb and the two fingers.

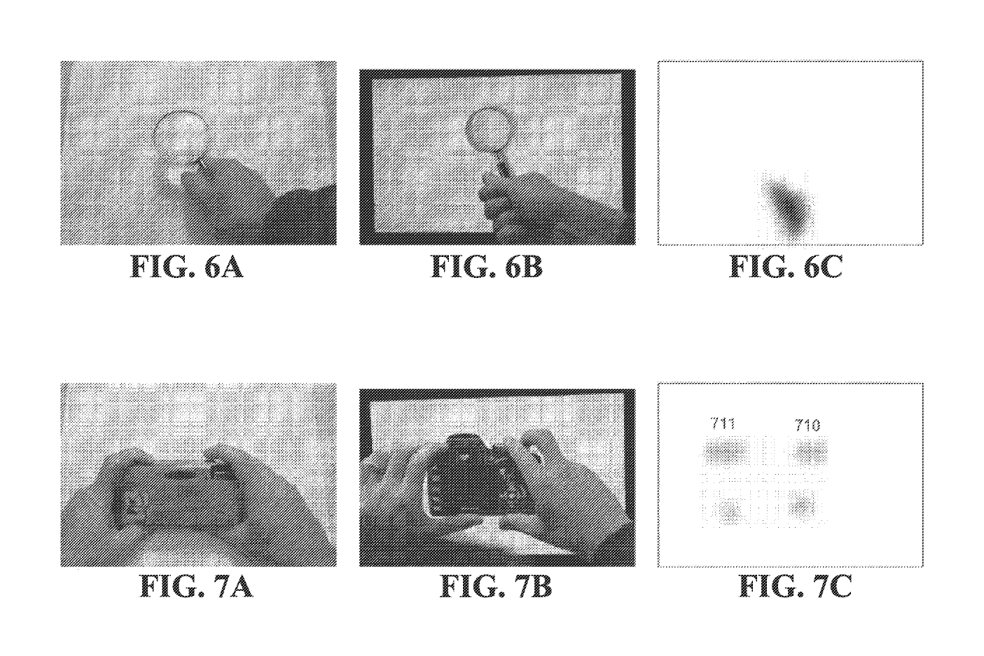

FIG. 6 shows an example using a virtual magnifier to control the action of image zoom. Once the magnifier grasp is identified, secondary actions may allow further control of the action. For example, the amount of zoom may be adjusted by secondary hand motions. In one example, one hand retains the magnifier grasp and the other hand motions the amount of zoom, or whether to increase or decrease zoom. Note also that the corresponding touch contact pattern in FIG. 6C (a simulated two-dimensional capacitive image) is not just finger tips. Pressing the hand to the touch screen creates a series of irregular contacts.

FIG. 7 shows an example using a virtual camera to control the action of image capture. This could be operation of the device's camera to capture images of the real world, or it could be capturing screen shots of the display. Note that the grasp involves two hands, which can be seen in the touch contact (a simulated two-dimensional capacitive image) of FIG. 7C. The three touch contacts 710 are the right thumb, index finger and middle finger; while the three touch contacts 720 are the left thumb, index finger and middle finger. Note also that the thumb touches are not finger tip touches. Rather, as can be seen in FIG. 7B, the side of the thumb is contacting the touch screen. This is just one example; other grasps are possible. The camera virtual tool is another example of a tool that could have secondary controls. Typically, there is a button on the upper right top of a camera, which can be depressed to take a photo. Thus, when using the camera virtual tool, the user can make a motion that appears as depressing his right index finger to trigger capturing an image. Additional controls such as zoom and flash may also be controlled by secondary controls, including other fingers.

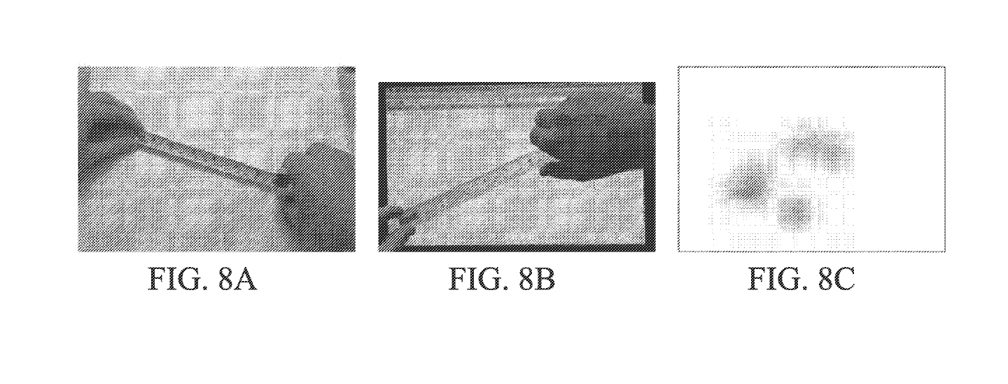

FIG. 8 shows an example using a virtual tape measure. As with the camera of FIG. 7, this grasp also uses two hands. The corresponding action could be measuring a distance, displaying a distance, or other types of distance functions. Note that the touch contact pattern shown in FIG. 8C is for use of a virtual tape measure, but not exactly for the position shown in FIG. 8B.

FIGS. 4-8 are just a few examples. Other examples will be apparent. For example, for the camera in FIG. 7, the positions of the touches could vary from that shown in FIG. 7C. The number of touch points can also vary. The camera could be held using just four fingers forming a rough rectangle. People can hold objects differently. In one approach, the system is preferably designed to recognize a wide variety of grasps, not just one.

Other virtual tools can also be realized. For example, virtual paint brushes can be used to control digital painting, and virtual highlighters can be used to control highlighting. There can also be a hierarchy of functions. The pen grasp, pencil grasp, paint brush grasp and highlighter grasp are fairly similar. Rather than trying to distinguish them based solely on the touch interactions, when one of the grasps is encountered, the system may produce a menu listing these different options. The user then selects which virtual tool he would like to use.

The following are some more examples. Virtual scissors, knives, scalpel or other types of cutting instruments may be used to control digital cutting. Virtual tweezers, pliers or other grasping instruments may be used to control digital grabbing of objects. Virtual imprint tools may be used to control digital stamping. Virtual pushpins or other fasteners may be used to control digital “pinning” objects together.

As another variation, grasps may be recognized based on information beyond or other than just the touch contact patterns. For example, the user interface may include three-dimensional imaging of the hands (e.g., using a depth camera) and this information could additionally be used to determine the grasps.

As described above, a touch analysis module (implemented by instructions 124 in this example) analyzes 220 the detected touch interaction as an initial step to determine the appropriate actions to take. In this example, the analysis determines whether the touch interaction is indicative of a grasp for manipulating a physical tool. If it is, then the electronic device 100 instantiates a corresponding virtual tool that controls an action similar to an action that may be taken by the physical tool. For example, the user may form his hand into the shape for grasping a physical pen, which is intended to instruct the device 100 to instantiate a virtual pen to draw on the display 120. As another example, the user may form two hands into the shape for grasping and operating a physical camera, which is intended to instruct the device 100 to instantiate a virtual camera to take a screen shot or to operate a physical camera within the device. The touch analysis module 124 determines which of these virtual tools, if any, are indicated by the detected touch interaction. Thus, non-limiting implementations as described herein comprise distinguishing between a first touch interaction, which has a first touch contact pattern, and a second touch interaction, which has a second touch contact pattern, based on difference between the touch contact patterns (e.g., one or more of position, shape, size, orientation, pressure, or contacting part(s) of a user's hand(s), wherein the first touch interaction and the second touch interaction are characterized by contact between the user's hand(s) and a touch screen associated with a device while the user's hand(s) are empty but formed into a shape defined by a grasp that is suitable for manipulating a particular physical tool, as provided above, and as further described herein. Further non-limiting implementations can comprise classifying a touch interaction as indicative of the particular physical tool based on the touch interaction being classified as any of a number of different touch interactions for the user's hand(s) formed into shapes defined by grasps that are suitable for manipulating the particular physical tool, wherein the number of different touch interactions associated with different ways for manipulating the particular physical tool are all classified as indicative of the particular physical tool, wherein the classifying the touch interaction includes classifying the touch interaction based on the distinguishing between the first touch interaction and the second touch interaction, and wherein the first touch interaction and second touch interaction correspond to different virtual tools, as provided above, and as further described herein.

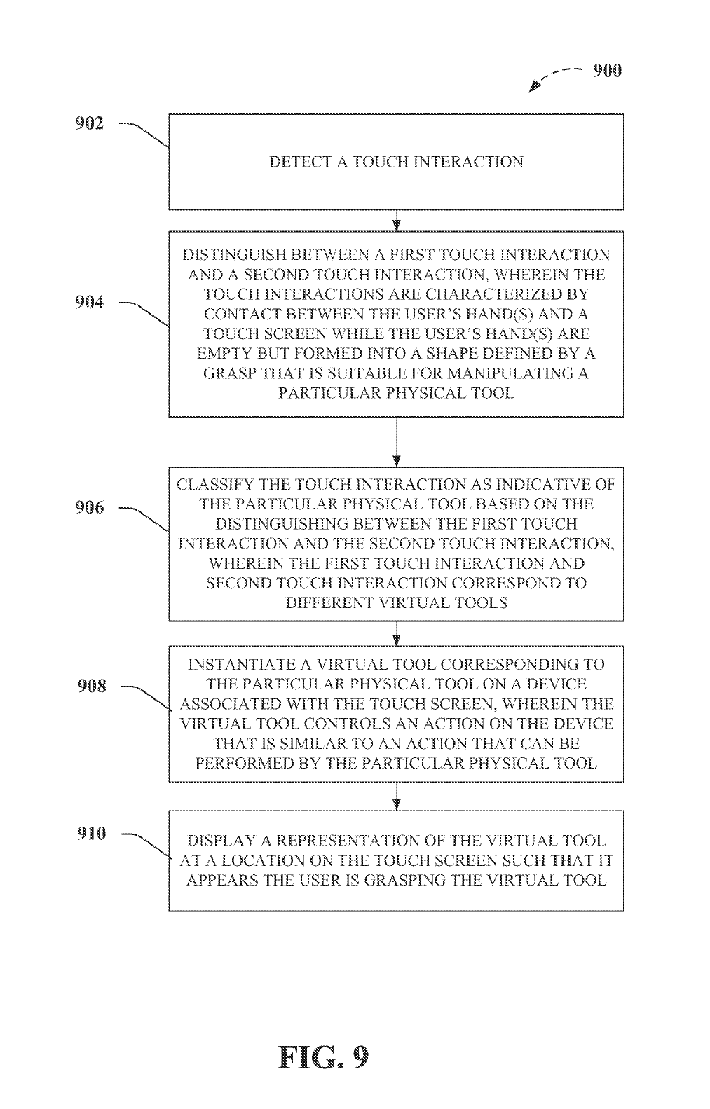

In view of the exemplary embodiments described supra, methods that can be implemented in accordance with the disclosed subject matter will be better appreciated with reference to the flowchart of FIG. 9. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be understood that various other branches, flow paths, and orders of the blocks, can be implemented which achieve the same or a similar result. Moreover, not all illustrated blocks may be required to implement the methods described hereinafter. Additionally, it should be further understood that the methods and/or functionality disclosed hereinafter and throughout this specification are capable of being stored on an article of manufacture to facilitate transporting and transferring such methods to computers, for example, as further described herein.

Accordingly, FIG. 9 illustrates an exemplary flow diagram of methods 900 directed to classifying touch interactions as indicative of a particular physical tool and further aspects of non-limiting aspects of the disclosed subject matter in accordance with the embodiments described herein. For example, exemplary methods 900 can comprise, at 902, detecting (e.g., via a device comprising a processor and associated with the touch screen, device 100, device 1002, etc.) a touch interaction (e.g., between a user and a touch screen associated with the device). In a non-limiting aspect, exemplary methods 900 can comprise detecting the touch interaction, wherein the touch interaction is characterized by a touch contact pattern including three or more simultaneous touch contacts on the touch screen by the user's hand(s) while the user's hand(s) are empty but formed into a shape defined by a grasp that is suitable for manipulating a particular physical tool, for example, as further described herein.

As a further non-limiting example, exemplary methods 900 can comprise, at 904, distinguishing between a first touch interaction and a second touch interaction, wherein the touch interactions are characterized by contact between the user's hand(s) and a touch screen while the user's hand(s) are empty but formed into a shape defined by a grasp that is suitable for manipulating a particular physical tool. As further described herein, exemplary methods 900 can comprise, at 904, distinguishing (e.g., by a device comprising a processor and associated with the touch screen, device 100, device 1002, etc.) between a first touch interaction, which has a first touch contact pattern associated with a first set of three or more simultaneous touch contacts, and a second touch interaction, which has a second touch contact pattern associated with a second set of three or more simultaneous touch contacts, based on one or more differences between one or more of position, shape, size, orientation, pressure, or contacting part(s), and so on, of a user's hand(s) of the first set of the three or more simultaneous touch contacts and the second set of the three or more simultaneous touch contacts, wherein the first touch interaction and the second touch interaction are characterized by contact between the user's hand(s) and a touch screen of the device while the user's hand(s) are empty but formed into a shape defined by a grasp that is suitable for manipulating a particular physical tool, according to further non-limiting aspects.

Accordingly, in further non-limiting aspects, exemplary methods 900 can comprise determining (e.g., via a device comprising a processor and associated with the touch screen, device 100, device 1002, etc.) one or more of position, shape, size, orientation, pressure, or contacting part(s) of the user's hand(s) of the first set, the second set, and so on of the three or more simultaneous touch contacts. As a non-limiting example, exemplary methods 900 can comprise determining (e.g., via a device comprising a processor and associated with the touch screen, device 100, device 1002, etc.) the one or more of position, shape, size, orientation, pressure, or contacting part(s) of the user's hand(s) of the first set, the second set, and so on of the three or more simultaneous touch contacts based on one or more of a number of touch points, an estimated total touch area, or magnitude of principle components of a point cloud associated with the three or more simultaneous touch contacts, as further described above. In further non-limiting examples, exemplary methods 900 can comprise determining (e.g., via a device comprising a processor and associated with the touch screen, device 100, device 1002, etc.) the one or more of position, shape, size, orientation, pressure, or contacting part(s) of the user's hand(s) of the first set, the second set, and so on of the three or more simultaneous touch contacts based on one or more statistical quantity associated with one or more of a distance between a pair of points associated with the three or more simultaneous touch contacts, another distance between respective points associated with the three or more simultaneous touch contacts and the point cloud, respective angles between adjacent points associated with the three or more simultaneous touch contacts, or one or more feature associated with an ellipse fitted to the estimated total touch area, wherein the one or more statistical quantity can comprises one or more of a mean, a median, a minimum, a maximum, or a standard deviation, and wherein the one or more feature associated with the ellipse fitted to the estimated total touch area can comprises one or more of a major axis length, a minor axis length, an eccentricity value, or an area value determined for the ellipse, as further described herein.

In a further non-limiting example, exemplary methods 900 can comprise, at 906, classifying a touch interaction as indicative of the particular physical tool based on the distinguishing between the first touch interaction and the second touch interaction, wherein the first touch interaction and second touch interaction correspond to different virtual tools. For instance, exemplary methods 900 can comprise, at 906, classifying (e.g., via a device comprising a processor and associated with the touch screen, device 100, device 1002, etc.) a touch interaction as indicative of the particular physical tool based on the touch interaction being classified as any of a number of different touch interactions for the user's hand(s) formed into shapes defined by grasps that are suitable for manipulating the particular physical tool, wherein the number of different touch interactions associated with different ways for manipulating the particular physical tool are all classified as indicative of the particular physical tool, wherein the classifying the touch interaction includes classifying the touch interaction based on the distinguishing between the first touch interaction and the second touch interaction, and wherein the first touch interaction and second touch interaction correspond to different virtual tools, according to further non-limiting aspects.

As a further non-limiting example, exemplary methods 900 can comprise, at 908, instantiating a virtual tool corresponding to the particular physical tool on the device associated with the touch screen, wherein the virtual tool controls an action on the device that is similar to an action that can be performed by the particular physical tool. For instance, exemplary methods 900 can comprise, at 908, in response to classifying the touch interaction as indicative of the particular physical tool, instantiating (e.g., via a device comprising a processor and associated with the touch screen, device 100, device 1002, etc.) a virtual tool corresponding to the particular physical tool, wherein the virtual tool controls an action on the device that is similar to an action that can be performed by the particular physical tool, according to further non-limiting aspects.

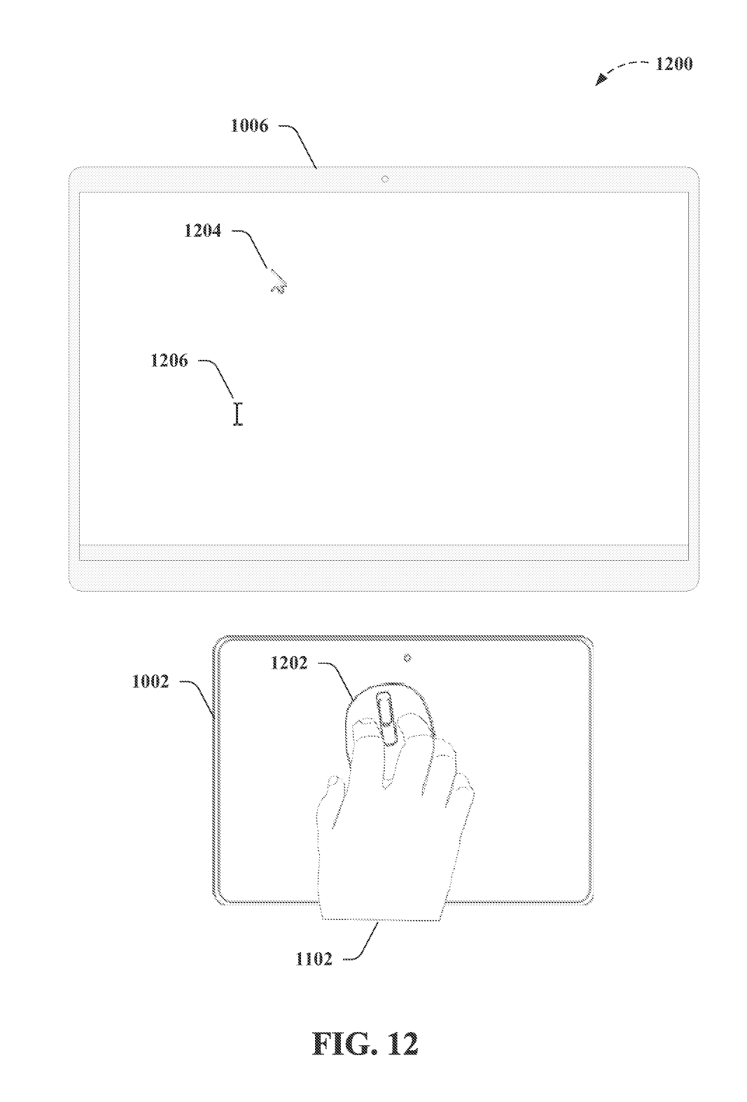

In still other non-limiting examples, exemplary methods 900 can comprise, at 910, displaying (e.g., via a device comprising a processor and associated with the touch screen, device 100, device 1002, etc.) a representation of the virtual tool at a location on the touch screen such that it appears the user is grasping the virtual tool. In a non-limiting aspect, exemplary methods 900 can comprise displaying an image associated with the particular physical tool. In still further non-limiting aspects of exemplary methods 900, displaying the image associated with the particular physical tool can comprise displaying the image associated with the particular physical tool comprising one or more of a dial, a mouse, a wheel, a turn knob, or a slider control. In other non-limiting aspects, a grasp (e.g., such as a grasp for a dial) can correspond to the particular physical tool (e.g., such as a dial), wherein the virtual tool (e.g., a virtual dial) corresponds to the particular physical tool, and wherein exemplary methods 900 can comprise displaying an image (e.g., on the device associate with touch screen, on a second device comprising a processor and communicatively coupled to the device, etc.), one or more user interface (UI) elements, and so on, which can be associated with an action to perform or cause to be performed (e.g., on the device associate with touch screen, on a second device comprising a processor and communicatively coupled to the device, etc.), for example, as further described herein, regarding FIGS. 12-17.

As further non-limiting examples, exemplary methods 900 can comprise, in response to detecting another touch interaction, causing (e.g., via a device comprising a processor and associated with the touch screen, device 100, device 1002, etc.) an action controlled by the virtual tool on the device to perform another action on a second device comprising a processor and communicatively coupled to the device, as further described herein regarding FIGS. 12-17.

As further non-limiting examples, exemplary methods 900 can comprise, detecting (e.g., via a device comprising a processor and associated with the touch screen, device 100, device 1002, etc.) motion associated with the another touch interaction, and/or in response to detecting the motion, adjusting (e.g., via a device comprising a processor and associated with the touch screen, device 100, device 1002, etc.) the representation of the virtual tool based on the detecting the motion and causing (e.g., via a device comprising a processor and associated with the touch screen, device 100, device 1002, etc.) to be performed the another action on the second device (e.g., a second device comprising a processor and communicatively coupled to the device, etc.), as further described herein regarding FIGS. 12-17.

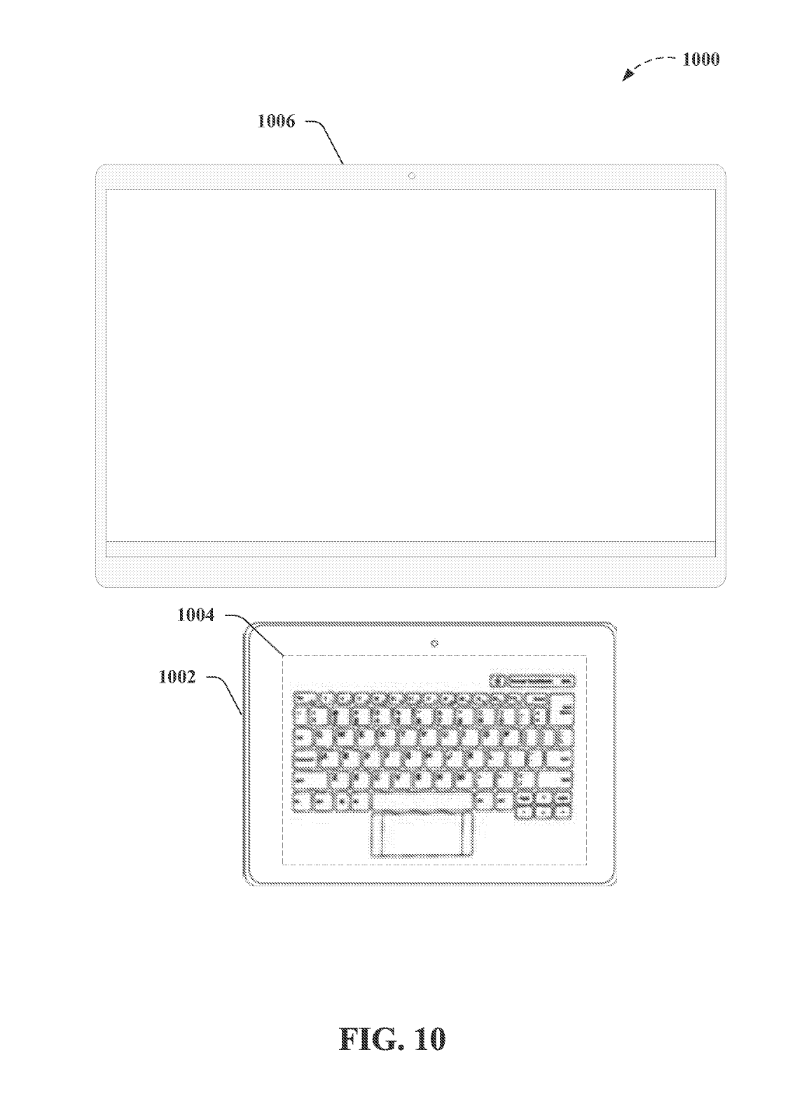

In still other non-limiting examples, exemplary methods 900 can comprise, detecting (e.g., via a device comprising a processor and associated with the touch screen, device 100, device 1002, etc.) an additional user action made by the user, and/or in response to detecting the additional user action, performing (e.g., via a device comprising a processor and associated with the touch screen, device 100, device 1002, etc.) the action on the device based on the additional user action, as further described herein regarding FIGS. 12-17. Further non-limiting aspects of exemplary embodiments of the disclosed subject matter can be illustrated by non-limiting examples described below regarding FIGS. 10-17.

For example, FIG. 10 depicts an exemplary operating environment 1000 in which various non-limiting embodiments as described herein can be practiced. For instance, exemplary operating environment 1000 is depicted with an exemplary device 1002 comprising a processor (e.g., a tablet computing device, exemplary device 100, etc.) and associated with a touch screen, which is depicted displaying a virtual keyboard and touchpad 1004. In various non-limiting aspects, exemplary operating environment 1000, exemplary device 1002 can be communicatively coupled (e.g., via a wired communication medium, via a wireless medication medium, etc.) to an exemplary second device 1006, which can also comprise or be associate with a processor, and which, in turn, can be communicatively coupled to the exemplary device 1002. Exemplary operating environment 1000 is depicted without a user interacting with exemplary device 1002 or exemplary second device 1006.

Accordingly, an exemplary device (e.g., device 100, device 1002, device or system 1800, combinations and/or portions thereof, etc.), as described herein, can comprise or be associated with a touch screen (e.g., comprising or associated with touch-sensitive surface 110, display 120, portions thereof, etc.), for example, as further described herein, regarding FIGS. 1-9, 11-21, etc.

In further non-limiting embodiments, exemplary device (e.g., device 100, device 1002, device or system 1800, combinations and/or portions thereof, etc.), as described herein, can comprise or be associated with a touch analysis module (e.g., touch analysis module 124, portions thereof, etc.) coupled to a processor (e.g., processor 102, processor 1804, combinations and/or portions thereof, etc.) for distinguishing between a first touch interaction, which has a first touch contact pattern associated with a first set of three or more simultaneous touch contacts, and a second touch interaction, which has a second touch contact pattern associated with a second set of the three or more simultaneous touch contacts, based on one or more difference between one or more of position, shape, size, orientation, pressure, or contacting part(s) of a user's hand(s) of the first set of the three or more simultaneous touch contacts and the second set of the three or more simultaneous touch contacts, wherein the first touch interaction and the second touch interaction are characterized by contact between the user's hand(s) and the touch screen (e.g., comprising or associated with touch-sensitive surface 110, display 120, portions thereof, etc.) of the device (e.g., device 100, device 1002, device or system 1800, combinations and/or portions thereof, etc.) while the user's hand(s) are empty but formed into a shape defined by a grasp that can be suitable for manipulating a particular physical tool, and for classifying a touch interaction as indicative of the particular physical tool based on the touch interaction being classified as any of a number of different touch interactions for the user's hand(s) formed into shapes defined by grasps that are suitable for manipulating the particular physical tool, wherein the number of different touch interactions associated with different ways for manipulating the particular physical tool are all classified as indicative of the particular physical tool, wherein the classifying the touch interaction includes classifying the touch interaction based on the distinguishing between the first touch interaction and the second touch interaction, and wherein the first touch interaction and second touch interaction correspond to different virtual tools, as further described herein, regarding FIGS. 1-9, 11-21, etc.

As a non-limiting example, exemplary touch analysis module (e.g., touch analysis module 124, portions thereof, etc.) can be further configured to determine the one or more of position, shape, size, orientation, pressure, or contacting part(s) of the user's hand(s) of the first set of the three or more simultaneous touch contacts, according to further non-limiting aspects. In addition, exemplary touch analysis module (e.g., touch analysis module 124, portions thereof, etc.) can be further configured to determine the one or more of position, shape, size, orientation, pressure, or contacting part(s) of the user's hand(s) of the first set of the three or more simultaneous touch contacts based on one or more of a number of touch points, an estimated total touch area, or magnitude of principle components of a point cloud associated with the three or more simultaneous touch contacts, as further described herein, for example, regarding FIGS. 9, 11-17, etc. In still further non-limiting aspects, exemplary touch analysis module (e.g., touch analysis module 124, portions thereof, etc.) can be further configured to determine the one or more of position, shape, size, orientation, pressure, or contacting part(s) of the user's hand(s) of the first set of the three or more simultaneous touch contacts based on one or more statistical quantity associated with one or more of a distance between a pair of points associated with the three or more simultaneous touch contacts, another distance between respective points associated with the three or more simultaneous touch contacts and the point cloud, respective angles between adjacent points associated with the three or more simultaneous touch contacts, or one or more feature associated with an ellipse fitted to the estimated total touch area, wherein the one or more statistical quantity can comprise one or more of a mean, a median, a minimum, a maximum, or a standard deviation, and wherein the one or more feature associated with the ellipse fitted to the estimated total touch area can comprise one or more of a major axis length, a minor axis length, an eccentricity value, or an area value determined for the ellipse.

As a further non-limiting example, for exemplary device (e.g., device 100, device 1002, device or system 1800, combinations and/or portions thereof, etc.), as described herein, exemplary processor (e.g., processor 102, processor 1804, combinations and/or portions thereof, etc.) can be configured to, in response to classifying the touch interaction as indicative of the particular physical tool, instantiating, by the device, a virtual tool corresponding to the particular physical tool, wherein the virtual tool controls an action on the device (e.g., device 100, device 1002, device or system 1800, combinations and/or portions thereof, etc.) that can be similar to an action that can be performed by the particular physical tool and instantiating the virtual tool includes displaying a representation of the virtual tool at a location on the touch screen (e.g., comprising or associated with touch-sensitive surface 110, display 120, portions thereof, etc.) such that it appears the user can be grasping the virtual tool. In a non-limiting aspect, the representation of the virtual tool can comprise an image associated with the particular physical tool, as further described herein, for example, regarding FIGS. 9, 11-17, etc. In yet another non-limiting aspect, the image associated with the particular physical tool can be associated with one or more of a dial, a mouse, a wheel, a turn knob, a slider control, and so on, without limitation.

In a further non-limiting example, for exemplary device (e.g., device 100, device 1002, device or system 1800, combinations and/or portions thereof, etc.), as described herein, exemplary touch screen (e.g., comprising or associated with touch-sensitive surface 110, display 120, portions thereof, etc.) can be coupled to detection circuitry (e.g., detection circuitry 112, portions thereof, etc.) that can be configured to detect the touch interaction characterized by a touch contact pattern including three or more simultaneous touch contacts on the touch screen (e.g., comprising or associated with touch-sensitive surface 110, display 120, portions thereof, etc.) by the user's hand(s) while the user's hand(s) are empty but formed into a shape defined by a grasp that can be suitable for manipulating a particular physical tool.

For instance, in a non-limiting aspect, exemplary detection circuitry (e.g., detection circuitry 112, portions thereof, etc.) can be further configured to detect another touch interaction, and wherein the processor (e.g., processor 102, processor 1804, combinations and/or portions thereof, etc.) can be further configured to cause the device (e.g., device 100, device 1002, device or system 1800, combinations and/or portions thereof, etc.) to perform another action on a second device (e.g., device 100, device 1002, device or system 1800, combinations and/or portions thereof, etc.) comprising a processor (e.g., processor 102, processor 1804, combinations and/or portions thereof, etc.) and communicatively coupled to the device, as further described herein, for example, regarding FIGS. 9, 11-17, etc.

In another non-limiting aspect, exemplary detection circuitry (e.g., detection circuitry 112, portions thereof, etc.) can be further configured to detect motion associated with the another touch interaction, and wherein the processor (e.g., processor 102, processor 1804, combinations and/or portions thereof, etc.) can be further configured to adjust the representation of the virtual tool based on the detecting the motion and cause the another action to be performed on the second device, as further described herein, for example, regarding FIGS. 9, 11-17, etc. In still another non-limiting aspect, exemplary detection circuitry (e.g., detection circuitry 112, portions thereof, etc.) can be further configured to detect an additional user action made by the user, and wherein the processor (e.g., processor 102, processor 1804, combinations and/or portions thereof, etc.) can be further configured to perform the action on the device (e.g., device 100, device 1002, device or system 1800, combinations and/or portions thereof, etc.) based on the additional user action, as further described herein, for example, regarding FIGS. 9, 11-17, etc.

As further described herein, exemplary device (e.g., device 100, device 1002, device or system 1800, combinations and/or portions thereof, etc.) can comprise a phone with the touch screen (e.g., comprising or associated with touch-sensitive surface 110, display 120, portions thereof, etc.), a tablet computer with the touch screen (e.g., comprising or associated with touch-sensitive surface 110, display 120, portions thereof, etc.), a computer with the touch screen (e.g., comprising or associated with touch-sensitive surface 110, display 120, portions thereof, etc.), an embedded control panel associated with the processor, and so on, without limitation, as further described herein.

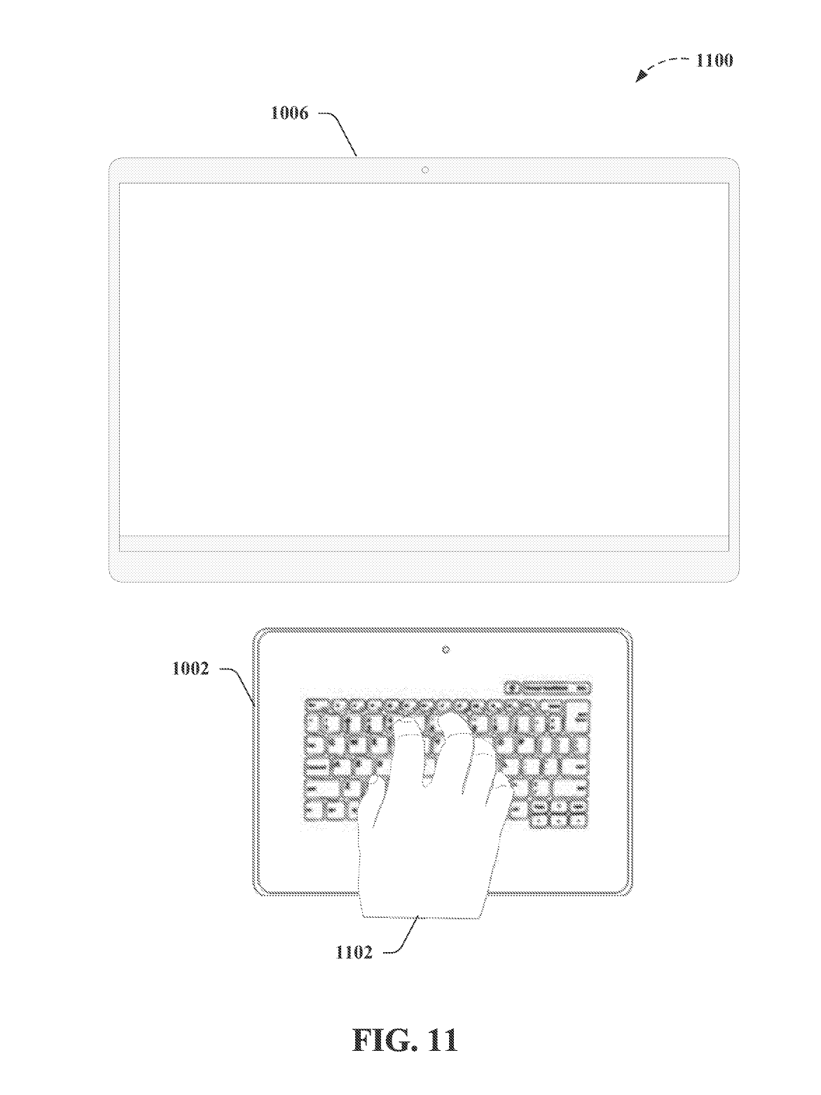

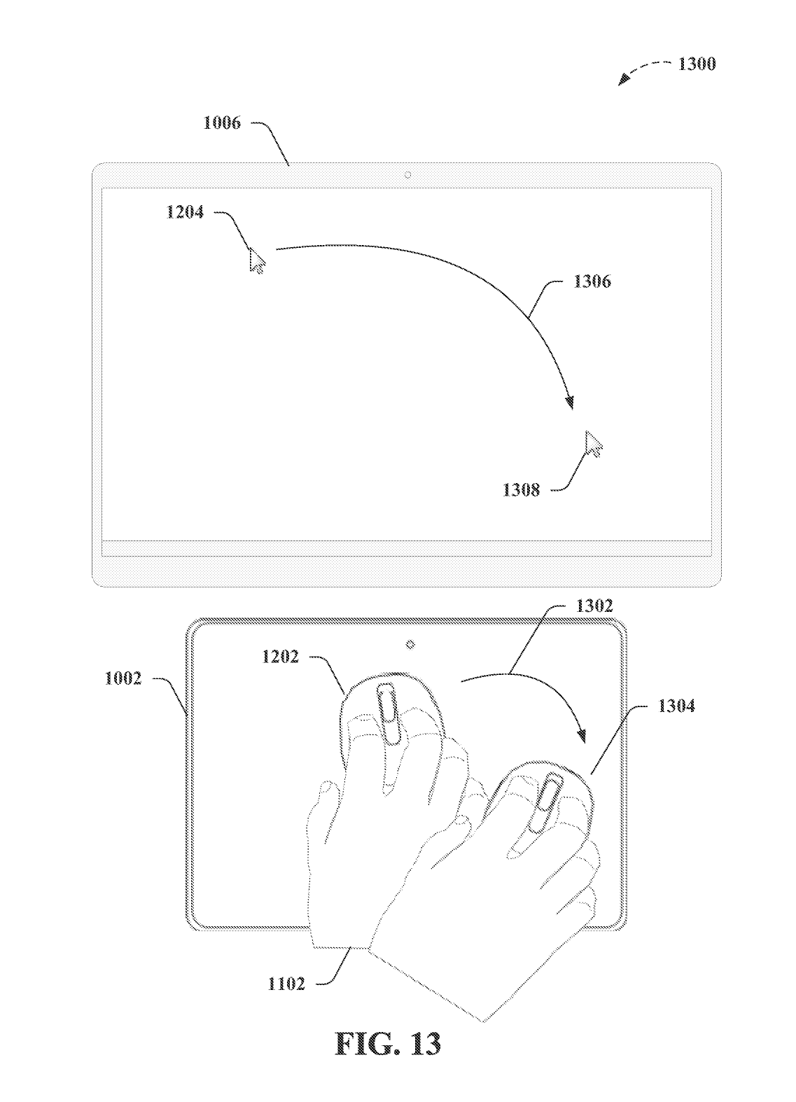

In a further non-limiting example, FIG. 11 depicts a non-limiting example of classifying touch interactions as indicative of a particular physical tool according to non-limiting aspects as described herein. For instance, FIG. 11 depicts the instant before a user's hand 1102 causes a touch interaction with exemplary device 1002, for example, as further described herein. FIG. 12 depicts another non-limiting example of classifying touch interactions as indicative of a particular physical tool according to further non-limiting aspects as described herein. For instance, FIG. 12 depicts a user's hand 1102 causing a touch interaction with exemplary device 1002. As further described herein, for example, regarding FIG. 9, exemplary device 1002 can facilitate detecting the touch interaction between the user's hand 1102 and the touch screen associated with exemplary device 1002. According to further non-limiting embodiments described herein, exemplary device 1002 can facilitate instantiating a virtual tool (e.g., virtual computer mouse 1202) corresponding to the particular physical tool (e.g., a physical computer mouse) on exemplary device 1002, wherein the virtual tool (e.g., virtual computer mouse 1202) controls an action on the device that is similar to an action that can be performed by the particular physical tool, for example, as further described herein regarding FIG. 13. As further described herein, in response to classifying (the distinguishing, etc.) the touch interaction as indicative of the particular physical tool (e.g., the physical computer mouse), exemplary device 1002 facilitates instantiating the virtual tool (e.g., virtual computer mouse 1202) corresponding to the particular physical tool, according to further non-limiting aspects.

Thus, as further described herein, exemplary device 1002 can facilitate displaying an image (e.g., an image of a computer mouse) associated with the particular physical tool (e.g., a physical computer mouse). In still further non-limiting aspects, exemplary device 1002 can facilitate displaying the image associated with the particular physical tool, which can comprise displaying the image associated with the particular physical tool comprising one or more of a dial, a mouse, a wheel, a turn knob, a slider control, and so on, without limitation, for example, as described herein, regarding FIGS. 12-17. As further depicted in FIG. 12, a grasp (e.g., such as a grasp for a dial) can correspond to the particular physical tool (e.g., such as a dial), wherein the virtual tool (e.g., a virtual dial) corresponds to the particular physical tool, and wherein exemplary methods 900 can comprise displaying an image (e.g., on exemplary device 1002, on exemplary second device 1006, etc.), one or more user interface (UI) elements, and so on, which can be associated with an action to perform or cause to be performed (e.g., on the device associate with touch screen, on a second device comprising a processor and communicatively coupled to the device, etc.), for example, as further described herein, regarding FIGS. 9 and 12-17. Thus, FIG. 12 depicts exemplary device 1002 facilitating the display of exemplary UI elements 1204 and 1206 (e.g., exemplary cursors) on exemplary second device 1006, for example, regarding performing or causing to be performed on exemplary second device 1006 another action. It can be understood that exemplary device 1002 can also facilitate the display of exemplary UI elements 1204 and 1206 on exemplary device 1002, according to various aspects as described herein, regarding controlling and action on exemplary device 1002.

FIG. 13 depicts a further non-limiting example of classifying touch interactions as indicative of a particular physical tool according to non-limiting aspects as described herein. For instance, FIG. 13 depicts exemplary device 1002 facilitating the detection of an exemplary motion 1302 associated with another touch interaction (e.g., exemplary motion 1302), and in response to exemplary device 1002 facilitating the detection of an exemplary motion 1302, facilitating the adjustment (e.g., exemplary motion 1302 of exemplary virtual mouse 1202 to a second screen location 1304) of the representation of the virtual tool (e.g., virtual mouse 1202) based on the detecting the exemplary motion 1302, and causing to be performed another action (e.g., exemplary motion 1306 of UI element 1204) on the exemplary second device 1006, as further described herein regarding FIGS. 9 and 14-17.

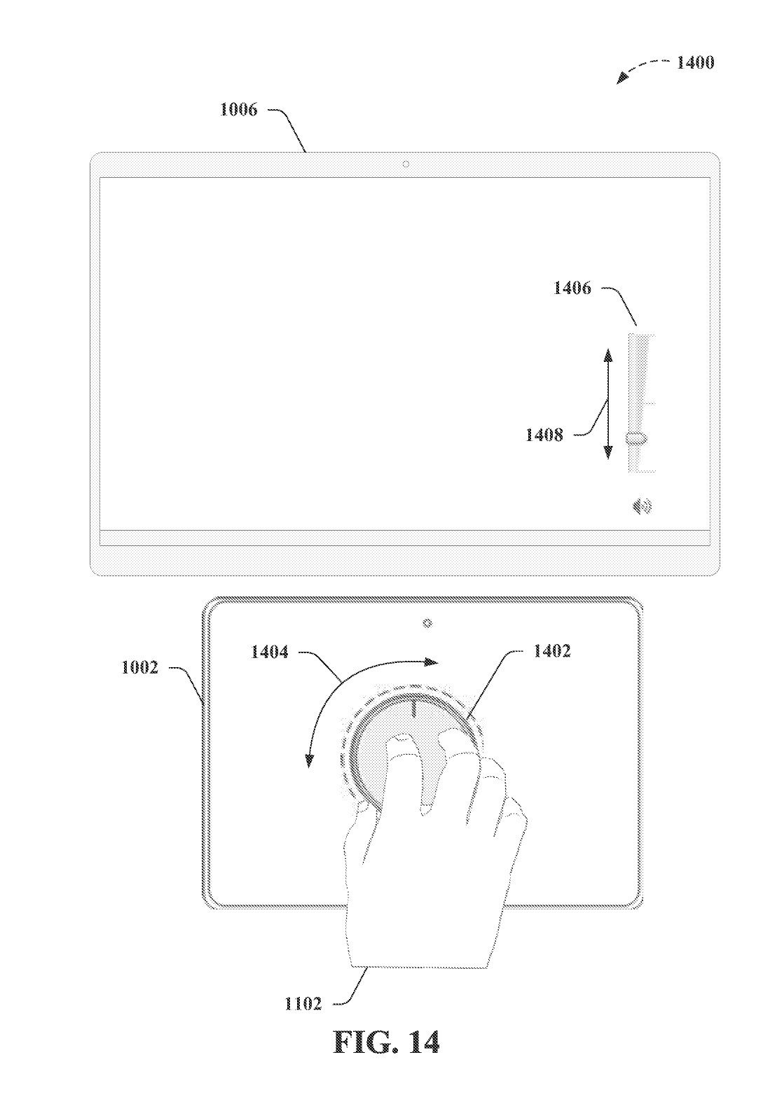

FIG. 14 depicts a non-limiting example of classifying touch interactions as indicative of a particular physical tool according to further non-limiting aspects as further described herein. For instance, FIG. 14 depicts exemplary device 1002 facilitating distinguishing between a first touch interaction, which has a first touch contact pattern associated with a first set of three or more simultaneous touch contacts (e.g., corresponding to a grasp that corresponds to a physical computer mouse), and a second touch interaction, which has a second touch contact pattern associated with a second set of three or more simultaneous touch contacts (e.g., corresponding to a grasp that corresponds to a physical dial), based on one or more differences between one or more of position, shape, size, orientation, pressure, or contacting part(s), and so on, of a user's hand(s) 1102 of the first set of the three or more simultaneous touch contacts and the second set of the three or more simultaneous touch contacts, wherein the first touch interaction and the second touch interaction are characterized by contact between the user's hand(s) 1102 and touch screen and exemplary device 1002 while the user's hand(s) 1102 are empty but formed into a shape defined by a grasp that is suitable for manipulating a particular physical tool (e.g., physical computer mouse, a physical dial, etc.), according to further non-limiting aspects, for example, as further described herein regarding FIG. 9. Accordingly, FIG. 14 depicts exemplary device 1002 facilitating classifying a touch interaction as indicative of the particular physical tool (e.g., a physical dial) based on the touch interaction being classified as any of a number of different touch interactions for exemplary user's hand(s) 1102 formed into shapes defined by grasps (e.g., a grasp that corresponds to a physical computer mouse, a grasp that corresponds to a physical dial, etc.) that are suitable for manipulating the particular physical tool (e.g., physical computer mouse, a physical dial, etc.), wherein the number of different touch interactions associated with different ways for manipulating the particular physical tool are all classified as indicative of the particular physical tool (e.g., a physical mouse with right button clicked, a physical mouse with left button clicked, a physical mouse with a scroll wheel manipulated, etc.), wherein the classifying the touch interaction includes classifying the touch interaction based on the distinguishing between the first touch interaction and the second touch interaction, and wherein the first touch interaction and second touch interaction correspond to different virtual tools (e.g., exemplary virtual mouse 1202, exemplary virtual dial 1402, etc), according to further non-limiting aspects.

In addition, FIG. 14 depicts exemplary device 1002 facilitating the display of exemplary UI element 1406 (e.g., exemplary volume slider control) on exemplary second device 1006, for example, regarding performing or causing to be performed on exemplary second device 1006 another action. FIG. 14 further depicts exemplary device 1002 facilitating the detection of an exemplary motion 1404 associated with another touch interaction (e.g., exemplary motion 1404), and in response to exemplary device 1002 facilitating the detection of an exemplary motion 1404, facilitating the adjustment (e.g., via exemplary motion 1404 of exemplary virtual dial 1402 to a second rotation position) of the representation of the virtual tool (e.g., exemplary virtual dial 1402) based on the detecting the exemplary motion 1404, and causing to be performed another action (e.g., exemplary motion 1408 of UI element 1406, and/or associated volume adjustment) on the exemplary second device 1006, as further described herein.

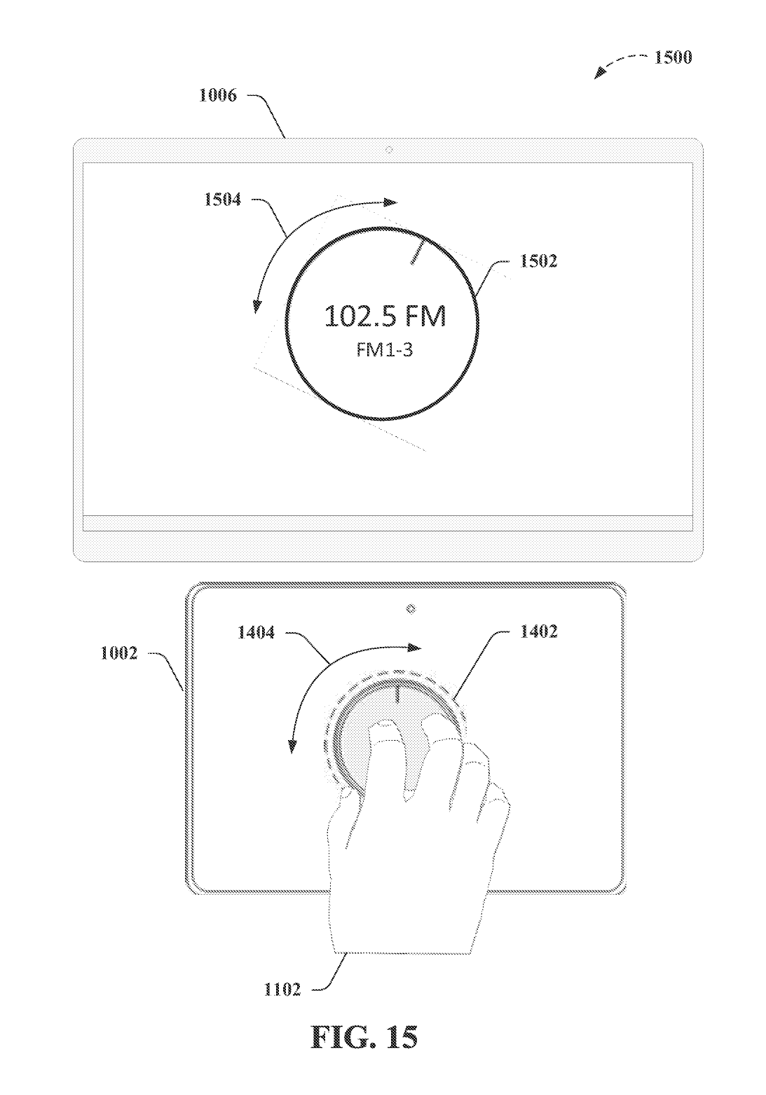

FIG. 15 depicts a further non-limiting example of classifying touch interactions as indicative of a particular physical tool according to further non-limiting aspects as described herein. As with FIG. 14, FIG. 15 depicts exemplary device 1002 facilitating the display of exemplary UI element 1502 (e.g., exemplary radio tuning display and dial UI element) on exemplary second device 1006, for example, regarding performing or causing to be performed on exemplary second device 1006 another action. FIG. 15 further depicts exemplary device 1002 facilitating the detection of an exemplary motion 1404 associated with another touch interaction (e.g., exemplary motion 1404), and in response to exemplary device 1002 facilitating the detection of an exemplary motion 1404, facilitating the adjustment (e.g., via exemplary motion 1404 of exemplary virtual dial 1402 to a second rotation position) of the representation of the virtual tool (e.g., exemplary virtual dial 1402) based on the detecting the exemplary motion 1404, and causing to be performed another action (e.g., adjustment indication 1504 of exemplary UI element 1502 (e.g., adjustment of radio tuning display and dial UI element, and/or associated tuner adjustment)) on the exemplary second device 1006, as further described herein.

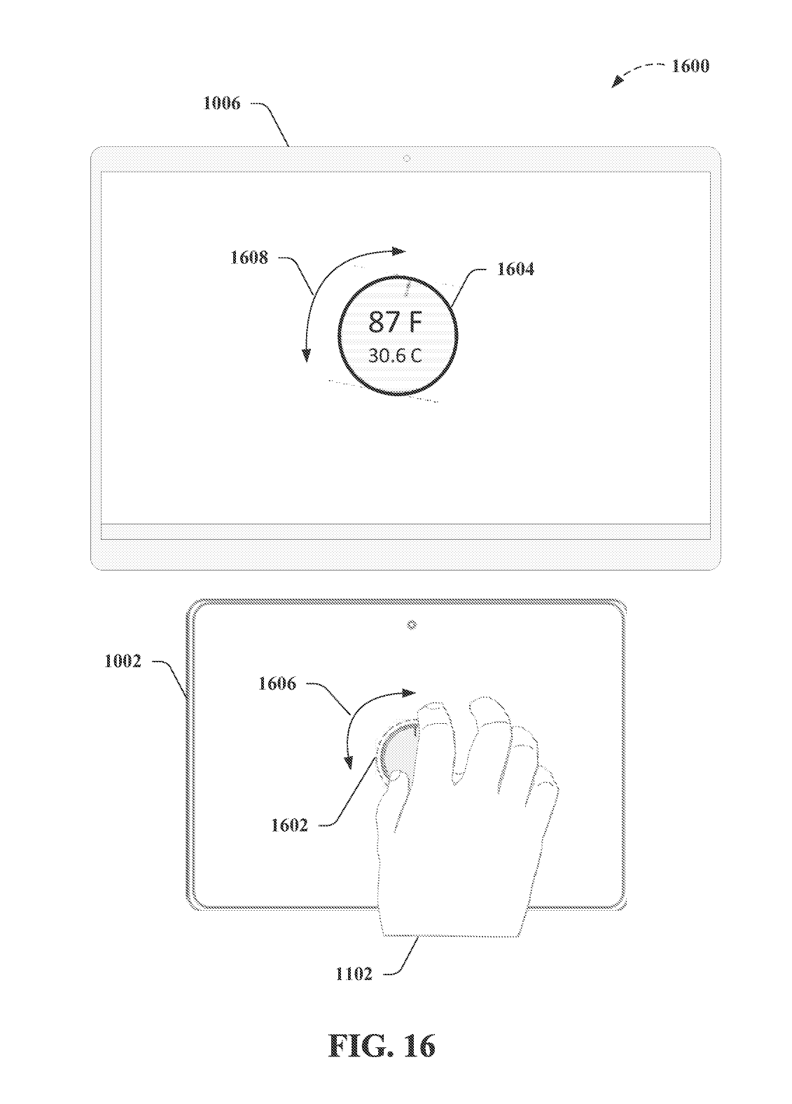

FIG. 16 depicts another non-limiting example of classifying touch interactions as indicative of a particular physical tool according to further non-limiting aspects as described herein. For example, as compared with FIGS. 14-15, FIG. 16 depicts exemplary device 1002 facilitating distinguishing between a first touch interaction, which has a first touch contact pattern associated with a first set of three or more simultaneous touch contacts (e.g., corresponding to a grasp that corresponds to a large physical dial classified as a first exemplary virtual dial 1402), and a second touch interaction, which has a second touch contact pattern associated with a second set of three or more simultaneous touch contacts (e.g., corresponding to a grasp that corresponds to a small physical dial classified as a second exemplary virtual dial 1602), based on one or more differences between one or more of position, shape, size, orientation, pressure, or contacting part(s), and so on, of a user's hand(s) 1102 of the first set of the three or more simultaneous touch contacts and the second set of the three or more simultaneous touch contacts, wherein the first touch interaction and the second touch interaction are characterized by contact between the user's hand(s) 1102 and touch screen and exemplary device 1002 while the user's hand(s) 1102 are empty but formed into a shape defined by a grasp that is suitable for manipulating a particular physical tool (e.g., a large physical dial, a small physical dial, etc.), according to further non-limiting aspects, for example, as further described herein regarding FIG. 9. Accordingly, FIG. 16 depicts exemplary device 1002 facilitating classifying a touch interaction as indicative of the particular physical tool (e.g., a small physical dial) based on the touch interaction being classified as any of a number of different touch interactions for exemplary user's hand(s) 1102 formed into shapes defined by grasps (e.g., a grasp that corresponds to a large physical dial, a grasp that corresponds to a small physical dial, etc.) that are suitable for manipulating the particular physical tool (e.g., a large physical dial, a small physical dial, etc.), wherein the number of different touch interactions associated with different ways for manipulating the particular physical tool (e.g., physical dial) are all classified as indicative of the particular physical tool (e.g., a large physical dial, a small physical dial, etc.), wherein the classifying the touch interaction includes classifying the touch interaction based on the distinguishing between the first touch interaction and the second touch interaction, and wherein the first touch interaction and second touch interaction correspond to different virtual tools (e.g., first exemplary virtual dial 1402, second exemplary virtual dial 1602, etc), according to further non-limiting aspects.

As with FIGS. 14-16, FIG. 16 depicts exemplary device 1002 facilitating the display of exemplary UI element 1604 (e.g., exemplary temperature display and thermostat UI element) on exemplary second device 1006, for example, regarding performing or causing to be performed on exemplary second device 1006 another action. FIG. 16 further depicts exemplary device 1002 facilitating the detection of an exemplary motion 1606 associated with another touch interaction (e.g., exemplary motion 1606), and in response to exemplary device 1002 facilitating the detection of an exemplary motion 1606, facilitating the adjustment (e.g., via exemplary motion 1606 of exemplary virtual dial 1602 to a second rotation position) of the representation of the virtual tool (e.g., exemplary virtual dial 1602) based on the detecting the exemplary motion 1606, and causing to be performed another action (e.g., adjustment indication 1608 of exemplary UI element 1604 (e.g., exemplary temperature display and thermostat UI element)) on the exemplary second device 1006, as further described herein.

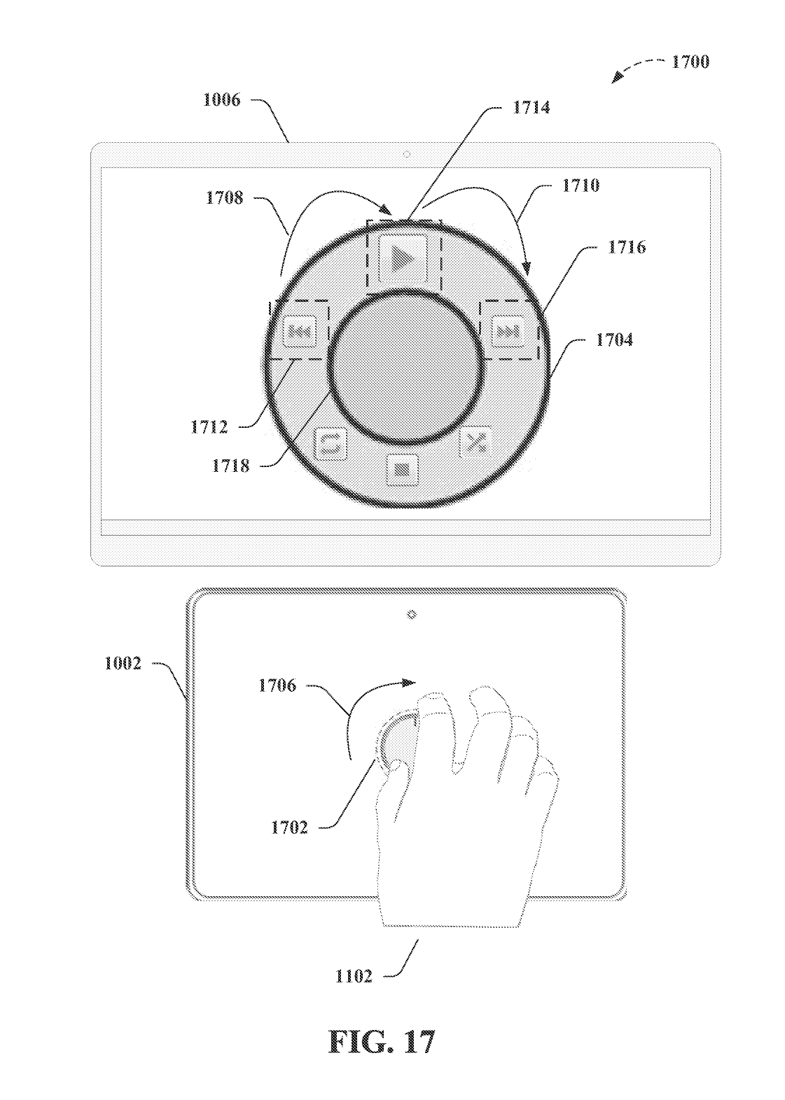

FIG. 17 depicts a further non-limiting example of classifying touch interactions as indicative of a particular physical tool according to other non-limiting aspects as described herein. For instance, as described above, a grasp (e.g., such as a grasp for a dial) can correspond to the particular physical tool (e.g., such as a dial), wherein the virtual tool (e.g., exemplary virtual dial 1702) corresponds to the particular physical tool, and wherein exemplary device 1002 can facilitate displaying an image (e.g., on exemplary device 1002, on exemplary second device 1006, etc.), one or more UI elements, and so on, such as exemplary UI element 1704 (e.g., audio player display and control, etc.) which can be associated with an action to perform or cause to be performed (e.g., on exemplary device 1002, on exemplary second device 1006, etc.), for example, as further described herein, regarding FIGS. 9, and 12-16. Thus, FIG. 17 depicts exemplary device 1002 facilitating the detection of an exemplary motion 1706 associated with another touch interaction (e.g., exemplary motion 1706), and in response to exemplary device 1002 facilitating the detection of an exemplary motion 1706, facilitating the adjustment (e.g., via exemplary motion 1706 of exemplary virtual dial 1702 to a second rotation position) of the representation of the virtual tool (e.g., exemplary virtual dial 1702) based on the detecting the exemplary motion 1706, and causing to be performed another action (e.g., indication and/or selection 1708, 1710 of exemplary UI element 1704 (e.g., audio player display and control, etc.) or portions thereof) on the exemplary second device 1006, as further described herein.

Accordingly, various embodiments as described herein can facilitate implementation of complex UI elements and systems based on touch interactions (e.g., on exemplary device 1002, on exemplary second device 1006, etc.), one or more UI elements, and so on, such as exemplary UI element 1704 (e.g., audio player display and control, etc.), which can be associated with an action to perform or cause to be performed (e.g., on exemplary device 1002, on exemplary second device 1006, etc.), for example, as further described herein, regarding FIGS. 9, and 12-16. As a non-limiting example, exemplary UI element 1704 (e.g., audio player display and control, etc.) can comprise further exemplary UI elements 1712 (e.g., an exemplary back UI element), 1714 (e.g., an exemplary play UI element), 1716 (e.g., an exemplary forward UI element), 1718 (e.g., an exemplary enter button UI element), and so on, without limitation.

It should be understood that exemplary UI element 1704 (e.g., audio player display and control, etc.) is described herein for the purposes of illustration, and not limitation. In other non-limiting embodiments, the disclosed subject matter can facilitate providing complex UI elements and systems based on touch interactions (e.g., on exemplary device 1002, on exemplary second device 1006, etc.), etc., for example, which can provide various contextual levels of actions that can be performed (e.g., on exemplary device 1002, on exemplary second device 1006, etc.), based on detecting touch interactions, distinguishing therebetween, classifying, and so on, as further described herein. As a further non-limiting example of a complex UI element and/or system based on touch interactions (e.g., on exemplary device 1002, on exemplary second device 1006, etc.), etc., for example, which can provide various contextual levels of actions that can be performed (e.g., on exemplary device 1002, on exemplary second device 1006, etc.), based on detecting touch interactions, the disclosed subject matter can facilitate providing color palette wheel UI element corresponding to an exemplary virtual dial, which corresponds to a grasp suitable for a particular physical tool comprising a physical dial.

As in FIG. 17, exemplary device 1002 can facilitate the adjustment (e.g., via exemplary motion 1706 of exemplary virtual dial 1702 to a second rotation position) of the representation of the virtual tool (e.g., exemplary virtual dial 1702) based on the detecting the exemplary motion 1706, and causing to be performed another action (e.g., indication and/or selection of an exemplary color palette wheel UI element, or portions thereof, on exemplary second device 1006, on exemplary device 1002, and so on), as further described herein. In the non-limiting example of an exemplary color palette wheel UI element, various subsequent touch interactions can be detected, distinguished, and/or classified, and so on, to navigate various components, options, menus, and the like of the exemplary color palette wheel UI element to facilitate performing and/or causing to be performed another action (e.g., indication and/or selection of an exemplary color palette wheel UI element, or portions thereof, on exemplary second device 1006, on exemplary device 1002, and so on), as further described herein.

Further non-limiting embodiments of the disclosed subject matter, for example, as depicted in FIGS. 10-17 can comprise one or more devices 1002, 1006, combinations, and/or portions thereof configured to perform various methods described herein, for example, regarding FIG. 9, or portions thereof, as well as other aspects as described herein.

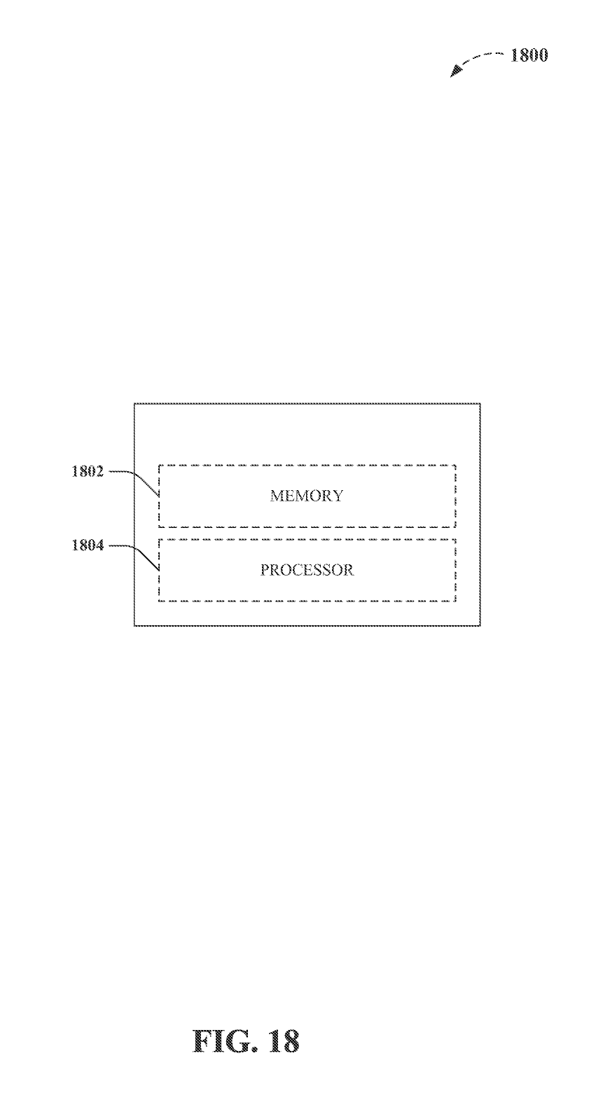

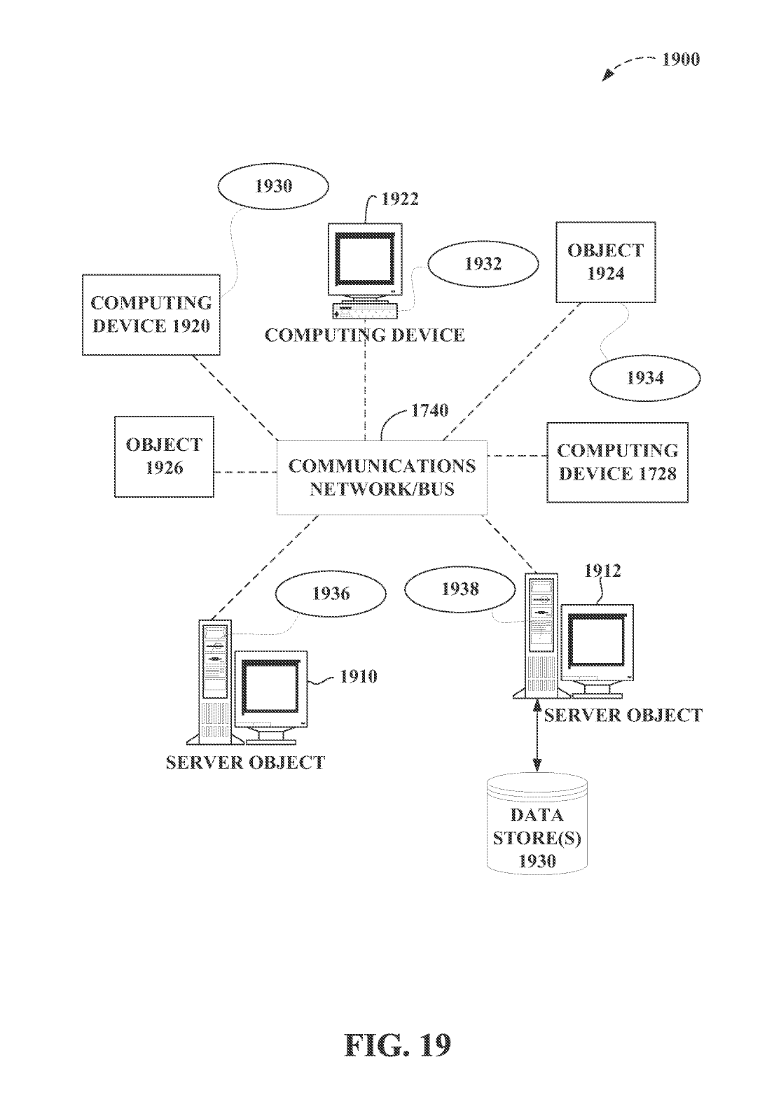

For example, FIG. 18 depicts an exemplary non-limiting device or system 1800 suitable for performing various aspects of the disclosed subject matter. The device or system 1800 can be a stand-alone device or a portion thereof, a specially programmed computing device or a portion thereof (e.g., a memory retaining instructions for performing the techniques as described herein coupled to a processor), and/or a composite device or system comprising one or more cooperating components distributed among several devices, as further described herein. As an example, exemplary non-limiting device or system 1800 can comprise exemplary devices and/or systems regarding FIGS. 10-17 as described above, or as further described below regarding FIGS. 19-21, for example, or portions thereof.

Accordingly, device or system 1800 can include a memory 1802 that retains various instructions with respect to facilitating various operations, for example, such as: distinguishing, (e.g., by a device comprising a processor and associated with the touch screen, device 100, device 1002, etc.), between a first touch interaction, which has a first touch contact pattern associated with a first set of three or more simultaneous touch contacts, and a second touch interaction, which has a second touch contact pattern associated with a second set of three or more simultaneous touch contacts, based on one or more differences between one or more of position, shape, size, orientation, pressure, or contacting part(s), and so on, of a user's hand(s) of the first set of the three or more simultaneous touch contacts and the second set of the three or more simultaneous touch contacts, wherein the first touch interaction and the second touch interaction are characterized by contact between the user's hand(s) and a touch screen of the device while the user's hand(s) are empty but formed into a shape defined by a grasp that is suitable for manipulating a particular physical tool; classifying (e.g., via a device comprising a processor and associated with the touch screen, device 100, device 1002, etc.) a touch interaction as indicative of the particular physical tool based on the touch interaction being classified as any of a number of different touch interactions for the user's hand(s) formed into shapes defined by grasps that are suitable for manipulating the particular physical tool, wherein the number of different touch interactions associated with different ways for manipulating the particular physical tool are all classified as indicative of the particular physical tool, wherein the classifying the touch interaction includes classifying the touch interaction based on the distinguishing between the first touch interaction and the second touch interaction, and wherein the first touch interaction and second touch interaction correspond to different virtual tools; and so on, as further described herein, regarding FIGS. 9-17.

The above example instructions and other suitable instructions for functionalities as described herein for example, regarding FIGS. 1-17, etc., can be retained within memory 1802, and a processor 1804 can be utilized in connection with executing the instructions.

In further non-limiting embodiments, an exemplary device (e.g., device 100, device 1002, device or system 1800, combinations and/or portions thereof, etc.), as described herein, can comprise or be associated with a touch screen (e.g., comprising or associated with touch-sensitive surface 110, display 120, portions thereof, etc.), for example, as further described herein, regarding FIGS. 1-21.

Various exemplary embodiments, as described herein regarding FIGS. 1-21, can comprise means for distinguishing between a first touch interaction, which has a first touch contact pattern associated with a first set of at least three simultaneous touch contacts, and a second touch interaction, which has a second touch contact pattern associated with a second set of the at least three simultaneous touch contacts, based at least in part on at least one difference between at least one of position, shape, size, orientation, pressure, or contacting part(s) of a user's hand(s) of the first set of the at least three simultaneous touch contacts and the second set of the at least three simultaneous touch contacts, wherein the first touch interaction and the second touch interaction are characterized by contact between the user's hand(s) and a touch screen of the device while the user's hand(s) are empty but formed into a shape defined by a grasp that is suitable for manipulating a particular physical tool

Further non-limiting embodiments, as described herein regarding FIGS. 1-21, can further comprise means for classifying a touch interaction as indicative of the particular physical tool based at least in part on the touch interaction being classified as any of a plurality of different touch interactions for the user's hand(s) formed into shapes defined by grasps that are suitable for manipulating the particular physical tool, wherein the plurality of different touch interactions associated with different ways for manipulating the particular physical tool are all classified as indicative of the particular physical tool, wherein the classifying the touch interaction includes classifying the touch interaction based on the distinguishing between the first touch interaction and the second touch interaction, and wherein the first touch interaction and second touch interaction correspond to different virtual tools.

In various non-limiting aspects, exemplary embodiments, as described herein regarding FIGS. 1-21, can further comprise one or more of means for, in response to classifying the touch interaction as indicative of the particular physical tool, instantiating, by the device, a virtual tool corresponding to the particular physical tool, wherein the virtual tool controls an action on the device that is similar to an action that can be performed by the particular physical tool and instantiating the virtual tool includes displaying a representation of the virtual tool at a location on the touch screen such that it appears the user is grasping the virtual tool, and/or means for detecting the touch interaction characterized by a touch contact pattern including at least three simultaneous touch contacts on the touch screen by the user's hand(s) while the user's hand(s) are empty but formed into a shape defined by a grasp that is suitable for manipulating a particular physical tool.

### Exemplary Networked and Distributed Environments

One of ordinary skill in the art can appreciate that the various embodiments of the disclosed subject matter and related systems, devices, and/or methods described herein can be implemented in connection with any computer or other client or server device, which can be deployed as part of a communications system, a computer network, and/or in a distributed computing environment, and can be connected to any kind of data store. In this regard, the various embodiments described herein can be implemented in any computer system or environment having any number of memory or storage units, and any number of applications and processes occurring across any number of storage units or volumes, which may be used in connection with communication systems using the techniques, systems, and methods in accordance with the disclosed subject matter. The disclosed subject matter can apply to an environment with server computers and client computers deployed in a network environment or a distributed computing environment, having remote or local storage. The disclosed subject matter can also be applied to standalone computing devices, having programming language functionality, interpretation and execution capabilities for generating, receiving, storing, and/or transmitting information in connection with remote or local services and processes.

Distributed computing provides sharing of computer resources and services by communicative exchange among computing devices and systems. These resources and services can include the exchange of information, cache storage and disk storage for objects, such as files. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices can have applications, objects or resources that may utilize disclosed and related systems, devices, and/or methods as described for various embodiments of the subject disclosure.

FIG. 19 provides a schematic diagram of an exemplary networked or distributed computing environment. The distributed computing environment comprises computing objects 1910, 1912, etc. and computing objects or devices 1920, 1922, 1924, 1926, 1928, etc., which may include programs, methods, data stores, programmable logic, etc., as represented by applications 1930, 1932, 1934, 1936, 1938. It can be understood that objects 1910, 1912, etc. and computing objects or devices 1920, 1922, 1924, 1926, 1928, etc. may comprise different devices, such as PDAs, audio/video devices, mobile phones, MP3 players, personal computers, laptops, etc.

Each object 1910, 1912, etc. and computing objects or devices 1920, 1922, 1924, 1926, 1928, etc. can communicate with one or more other objects 1910, 1912, etc. and computing objects or devices 1920, 1922, 1924, 1926, 1928, etc. by way of the communications network 1940, either directly or indirectly. Even though illustrated as a single element in FIG. 19, network 1940 may comprise other computing objects and computing devices that provide services to the system of FIG. 19, and/or may represent multiple interconnected networks, which are not shown. Each object 1910, 1912, etc. or 1920, 1922, 1924, 1926, 1928, etc. can also contain an application, such as applications 1930, 1932, 1934, 1936, 1938, that can make use of an API, or other object, software, firmware and/or hardware, suitable for communication with or implementation of disclosed and related systems, devices, methods, and/or functionality provided in accordance with various embodiments of the subject disclosure. Thus, although the physical environment depicted may show the connected devices as computers, such illustration is merely exemplary and the physical environment may alternatively be depicted or described comprising various digital devices, any of which can employ a variety of wired and/or wireless services, software objects such as interfaces, COM objects, and the like.

There are a variety of systems, components, and network configurations that support distributed computing environments. For example, computing systems can be connected together by wired or wireless systems, by local networks or widely distributed networks. Currently, many networks are coupled to the Internet, which can provide an infrastructure for widely distributed computing and can encompass many different networks, though any network infrastructure can be used for exemplary communications made incident to employing disclosed and related systems, devices, and/or methods as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 19, as a non-limiting example, computers 1920, 1922, 1924, 1926, 1928, etc. can be thought of as clients and computers 1910, 1912, etc. can be thought of as servers where servers 1910, 1912, etc. provide data services, such as receiving data from client computers 1920, 1922, 1924, 1926, 1928, etc., storing of data, processing of data, transmitting data to client computers 1920, 1922, 1924, 1926, 1928, etc., although any computer can be considered a client, a server, or both, depending on the circumstances. Any of these computing devices may be processing data, forming metadata, synchronizing data or requesting services or tasks that may implicate disclosed and related systems, devices, and/or methods as described herein for one or more embodiments.

A server is typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to disclosed and related systems, devices, and/or methods can be provided standalone, or distributed across multiple computing devices or objects.

In a network environment in which the communications network/bus 1940 is the Internet, for example, the servers 1910, 1912, etc. can be Web servers with which the clients 1920, 1922, 1924, 1926, 1928, etc. communicate via any of a number of known protocols, such as the hypertext transfer protocol (HTTP). Servers 1910, 1912, etc. may also serve as clients 1920, 1922, 1924, 1926, 1928, etc., as may be characteristic of a distributed computing environment.

### Exemplary Computing Device

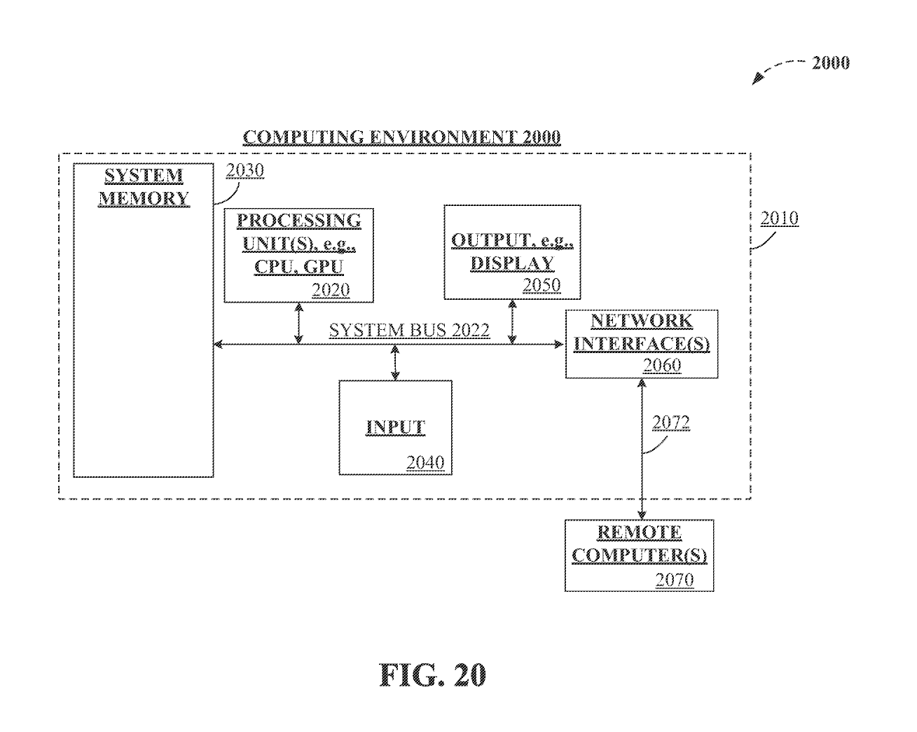

As mentioned, advantageously, the techniques described herein can be applied to devices or systems where it is desirable to employ disclosed and related systems, devices, and/or methods. It should be understood, therefore, that handheld, portable and other computing devices and computing objects of all kinds are contemplated for use in connection with the various disclosed embodiments. Accordingly, the below general purpose remote computer described below in FIG. 20 is but one example of a computing device. Additionally, disclosed and related systems, devices, and/or methods can include one or more aspects of the below general purpose computer, such as display, storage, analysis, control, etc.

Although not required, embodiments can partly be implemented via an operating system, for use by a developer of services for a device or object, and/or included within application software that operates to perform one or more functional aspects of the various embodiments described herein. Software can be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 20 thus illustrates an example of a suitable computing system environment 2000 in which one or aspects of the embodiments described herein can be implemented, although as made clear above, the computing system environment 2000 is only one example of a suitable computing environment and is not intended to suggest any limitation as to scope of use or functionality. Neither should the computing environment 2000 be interpreted as having any dependency or requirement relating to any one or combination of components illustrated in the exemplary operating environment 2000.

With reference to FIG. 20, an exemplary remote device for implementing one or more embodiments includes a general purpose computing device in the form of a computer 2010. Components of computer 2010 can include, but are not limited to, a processing unit 2020, a system memory 2030, and a system bus 2022 that couples various system components including the system memory to the processing unit 2020.

Computer 2010 typically includes a variety of computer readable media and can be any available media that can be accessed by computer 2010. The system memory 2030 can include computer storage media in the form of volatile and/or nonvolatile memory such as read only memory (ROM) and/or random access memory (RAM). By way of example, and not limitation, memory 2030 can also include an operating system, application programs, other program modules, and program data.

A user can enter commands and information into the computer 2010 through input devices 2040. A monitor or other type of display device is also connected to the system bus 2022 via an interface, such as output interface 2050. In addition to a monitor, computers can also include other peripheral output devices such as speakers and a printer, which can be connected through output interface 2050.

The computer 2010 can operate in a networked or distributed environment using logical connections to one or more other remote computers, such as remote computer 2070. The remote computer 2070 can be a personal computer, a server, a router, a network PC, a peer device or other common network node, or any other remote media consumption or transmission device, and can include any or all of the elements described above relative to the computer 2010. The logical connections depicted in FIG. 20 include a network 2072, such local area network (LAN) or a wide area network (WAN), but can also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts can be applied to any network system and any computing device or system in which it is

Also, there are multiple ways to implement the same or similar functionality, e.g., an appropriate API, tool kit, driver code, operating system, control, standalone or downloadable software object, etc. which enables applications and services to use disclosed and related systems, devices, methods, and/or functionality. Thus, embodiments herein are contemplated from the standpoint of an API (or other software object), as well as from a software or hardware object that implements one or more aspects of disclosed and related systems, devices, and/or methods as described herein. Thus, various embodiments described herein can have aspects that are wholly in hardware, partly in hardware and partly in software, as well as in software.

### Exemplary Mobile Device

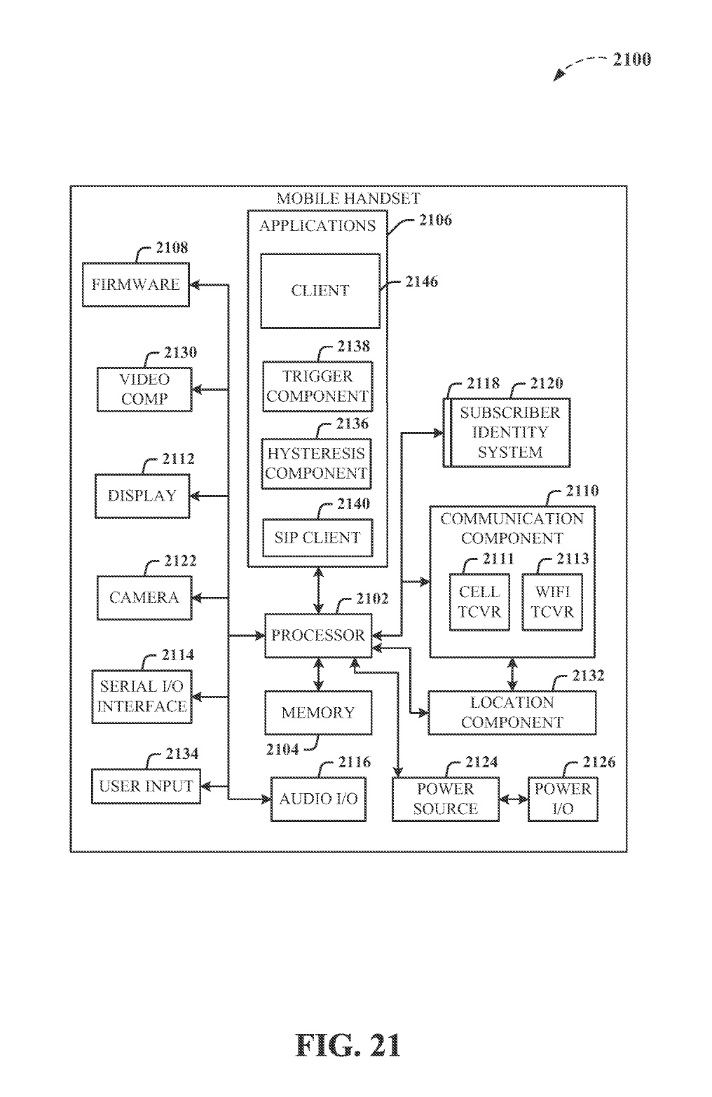

FIG. 21 depicts a schematic diagram of an exemplary mobile device 2100 (e.g., a mobile handset) that can facilitate various non-limiting aspects of the disclosed subject matter in accordance with the embodiments described herein. Although a mobile handset 2100 is illustrated herein, it will be understood that other devices can be a device or a mobile device, as described herein, for instance, and that the mobile handset 2100 is merely illustrated to provide context for the embodiments of the subject matter described herein. The following discussion is intended to provide a brief, general description of an example of a suitable environment 2100 in which the various embodiments can be implemented. While the description includes a general context of computer-executable instructions embodied on a tangible computer readable storage medium, those skilled in the art will recognize that the subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of computer readable media. Computer readable media can comprise any available media that can be accessed by the computer and includes both volatile and non-volatile media, removable and non-removable media. By way of example and not limitation, computer readable media can comprise tangible computer readable storage and/or communication media. Tangible computer readable storage can include volatile and/or non-volatile media, removable and/or non-removable media implemented in any method or technology for storage of information, such as computer readable instructions, data structures, program modules, or other data. Tangible computer readable storage can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media, as contrasted with tangible computer readable storage, typically embodies computer readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable communications media as distinguishable from computer-readable storage media.

The handset 2100 can include a processor 2102 for controlling and processing all onboard operations and functions. A memory 2104 interfaces to the processor 2102 for storage of data and one or more applications 2106 (e.g., communications applications such as browsers, apps, etc.). Other applications can support operation of communications and/or financial communications protocols. The applications 2106 can be stored in the memory 2104 and/or in a firmware 2108, and executed by the processor 2102 from either or both the memory 2104 or/and the firmware 2108. The firmware 2108 can also store startup code for execution in initializing the handset 2100. A communications component 2110 interfaces to the processor 2102 to facilitate wired/wireless communication with external systems, e.g., cellular networks, VoIP networks, and so on. Here, the communications component 2110 can also include a suitable cellular transceiver 2111 (e.g., a GSM transceiver) and/or an unlicensed transceiver 2113 (e.g., Wireless Fidelity (WiFi™), Worldwide Interoperability for Microwave Access (WiMax®)) for corresponding signal communications. The handset 2100 can be a device such as a cellular telephone, a PDA with mobile communications capabilities, and messaging-centric devices. The communications component 2110 also facilitates communications reception from terrestrial radio networks (e.g., broadcast), digital satellite radio networks, and Internet-based radio services networks.

The handset 2100 includes a display 2112 for displaying text, images, video, telephony functions (e.g., a Caller ID function), setup functions, and for user input. For example, the display 2112 can also be referred to as a “screen” that can accommodate the presentation of multimedia content (e.g., music metadata, messages, wallpaper, graphics, etc.). The display 2112 can also display videos and can facilitate the generation, editing and sharing of video quotes. A serial I/O interface 2114 is provided in communication with the processor 2102 to facilitate wired and/or wireless serial communications (e.g., Universal Serial Bus (USB), and/or Institute of Electrical and Electronics Engineers (IEEE) 2194) through a hardwire connection, and other serial input devices (e.g., a keyboard, keypad, and mouse). This supports updating and troubleshooting the handset 2100, for example. Audio capabilities are provided with an audio I/O component 2116, which can include a speaker for the output of audio signals related to, for example, indication that the user pressed the proper key or key combination to initiate the user feedback signal. The audio I/O component 2116 also facilitates the input of audio signals through a microphone to record data and/or telephony voice data, and for inputting voice signals for telephone conversations.

The handset 2100 can include a slot interface 2118 for accommodating a SIC (Subscriber Identity Component) in the form factor of a card Subscriber Identity Module (SIM) or universal SIM 2120, and interfacing the SIM card 2120 with the processor 2102. However, it is to be appreciated that the SIM card 2120 can be manufactured into the handset 2100, and updated by downloading data and software.

The handset 2100 can process Internet Protocol (IP) data traffic through the communication component 2110 to accommodate IP traffic from an IP network such as, for example, the Internet, a corporate intranet, a home network, a person area network, etc., through an ISP or broadband cable provider. Thus, VoIP traffic can be utilized by the handset 2100 and IP-based multimedia content can be received in either an encoded or a decoded format.

A video processing component 2122 (e.g., a camera and/or associated hardware, software, etc.) can be provided for decoding encoded multimedia content. The video processing component 2122 can aid in facilitating the generation and/or sharing of video. The handset 2100 also includes a power source 2124 in the form of batteries and/or an alternating current (AC) power subsystem, which power source 2124 can interface to an external power system or charging equipment (not shown) by a power input/output (I/O) component 2126.

The handset 2100 can also include a video component 2130 for processing video content received and, for recording and transmitting video content. For example, the video component 2130 can facilitate the generation, editing and sharing of video. A location-tracking component 2132 facilitates geographically locating the handset 2100. A user input component 2134 facilitates the user inputting data and/or making selections as previously described. The user input component 2134 can also facilitate selecting perspective recipients for fund transfer, entering amounts requested to be transferred, indicating account restrictions and/or limitations, as well as composing messages and other user input tasks as required by the context. The user input component 2134 can include such conventional input device technologies such as a keypad, keyboard, mouse, stylus pen, and/or touch screen, for example.

Referring again to the applications 2106, a hysteresis component 2136 facilitates the analysis and processing of hysteresis data, which is utilized to determine when to associate with an access point. A software trigger component 2138 can be provided that facilitates triggering of the hysteresis component 2138 when a WiFi™ transceiver 2113 detects the beacon of the access point. A SIP client 2140 enables the handset 2100 to support SIP protocols and register the subscriber with the SIP registrar server. The applications 2106 can also include a communications application or client 2146 that, among other possibilities, can facilitate user interface component functionality as described above.

The handset 2100, as indicated above related to the communications component 2110, includes an indoor network radio transceiver 2113 (e.g., WiFi™ transceiver). This function supports the indoor radio link, such as IEEE 802.11, for the dual-mode Global System for Mobile Communications (GSM) handset 2100. The handset 2100 can accommodate at least satellite radio services through a handset that can combine wireless voice and digital radio chipsets into a single handheld device.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

The terms “module,” “component,” etc. is not meant to be limited to a specific physical form. Depending on the specific application, modules can be implemented as hardware, firmware, software, and/or combinations of these. Furthermore, different modules can share common components or even be implemented by the same components. There may or may not be a clear boundary between different modules.

Depending on the form of the modules, the “coupling” between modules may also take different forms. Dedicated circuitry can be coupled to each other by hardwiring or by accessing a common register or memory location, for example. Software “coupling” can occur by any number of ways to pass information between software components (or between software and hardware, if that is the case). The term “coupling” is meant to include all of these and is not meant to be limited to a hardwired permanent connection between two components. In addition, there may be intervening elements. For example, when two elements are described as being coupled to each other, this does not imply that the elements are directly coupled to each other nor does it preclude the use of other elements between the two.

What is claimed is:

1. A method, comprising:
distinguishing, by a device comprising a processor, between a first touch interaction, which has a first touch contact pattern associated with a first set of at least three simultaneous touch contacts, and a second touch interaction, which has a second touch contact pattern associated with a second set of the at least three simultaneous touch contacts, based at least in part on at least one difference between at least one of position, shape, size, orientation, pressure, or contacting part(s) of a user's hand(s) of the first set of the at least three simultaneous touch contacts and the second set of the at least three simultaneous touch contacts, wherein the first touch interaction and the second touch interaction are characterized by contact between the user's hand(s) and a touch screen of the device while the user's hand(s) are empty but formed into a shape defined by a grasp that is suitable for manipulating a particular physical tool; and
classifying, by the device, a touch interaction as indicative of the particular physical tool based at least in part on the touch interaction being classified as any of a plurality of different touch interactions for the user's hand(s) formed into shapes defined by grasps that are suitable for manipulating the particular physical tool, wherein the plurality of different touch interactions associated with different ways for manipulating the particular physical tool are all classified as indicative of the particular physical tool, wherein the classifying the touch interaction includes classifying the touch interaction based on the distinguishing between the first touch interaction and the second touch interaction, and wherein the first touch interaction and second touch interaction correspond to different virtual tools.

2. The method of claim 1, further comprising:
in response to classifying the touch interaction as indicative of the particular physical tool, instantiating, by the device, a virtual tool corresponding to the particular physical tool, wherein the virtual tool controls an action on the device that is similar to an action that can be performed by the particular physical tool and instantiating the virtual tool includes displaying a representation of the virtual tool at a location on the touch screen such that it appears the user is grasping the virtual tool.

3. The method of claim 2, further comprising:
in response to detecting another touch interaction, causing, by the device, the action controlled by the virtual tool on the device to perform another action on a second device comprising a processor and communicatively coupled to the device.

4. The method of claim 3, further comprising:
detecting, by the device, motion associated with the another touch interaction; and
in response to detecting the motion, adjusting, by the device, the representation of the virtual tool based at least in part on the detecting the motion and causing, by the device, to be performed the another action on the second device.

5. The method of claim 2, further comprising:
detecting, by the device, an additional user action made by the user; and
in response to detecting the additional user action, performing, by the device, the action on the device based at least in part on the additional user action.

6. The method of claim 2, wherein the displaying the representation of the virtual tool comprises displaying an image associated with the particular physical tool.

7. The method of claim 6, wherein the displaying the image associated with the particular physical tool comprises displaying the image associated with the particular physical tool comprising at least one of a dial, a mouse, a wheel, a turn knob, or a slider control.

8. The method of claim 1, further comprising:
determining, by the device, the at least one of position, shape, size, orientation, pressure, or contacting part(s) of the user's hand(s) of the first set of the at least three simultaneous touch contacts.

9. The method of claim 8, wherein the determining the at least one of position, shape, size, orientation, pressure, or contacting part(s) of the user's hand(s) of the first set of the at least three simultaneous touch contacts comprises the determining, by the device, based at least in part on at least one of a number of touch points, an estimated total touch area, or magnitude of principle components of a point cloud associated with the at least three simultaneous touch contacts.

10. The method of claim 8, wherein the determining the at least one of position, shape, size, orientation, pressure, or contacting part(s) of the user's hand(s) of the first set of the at least three simultaneous touch contacts comprises the determining, by the device, based at least in part on at least one statistical quantity associated with at least one of a distance between a pair of points associated with the at least three simultaneous touch contacts, another distance between respective points associated with the at least three simultaneous touch contacts and the point cloud, respective angles between adjacent points associated with the at least three simultaneous touch contacts, or at least one feature associated with an ellipse fitted to the estimated total touch area, wherein the at least one statistical quantity comprises at least one of a mean, a median, a minimum, a maximum, or a standard deviation, and wherein the at least one feature associated with the ellipse fitted to the estimated total touch area comprises at least one of a major axis length, a minor axis length, an eccentricity value, or an area value determined for the ellipse.

11. A machine-readable tangible storage medium having stored thereon data representing sequences of instructions, which when executed by an electronic device having a touch screen touch sensitive surface, cause the electronic device to perform a method comprising the steps of:
distinguishing, by a device comprising a processor, between a first touch interaction, which has a first touch contact pattern associated with a first set of at least three simultaneous touch contacts, and a second touch interaction, which has a second touch contact pattern associated with a second set of the at least three simultaneous touch contacts, based at least in part on at least one difference between at least one of position, shape, size, orientation, pressure, or contacting part(s) of a user's hand(s) of the first set of the at least three simultaneous touch contacts and the second set of the at least three simultaneous touch contacts, wherein the first touch interaction and the second touch interaction are characterized by contact between the user's hand(s) and a touch screen of the device while the user's hand(s) are empty but formed into a shape defined by a grasp that is suitable for manipulating a particular physical tool; and
classifying, by the device a touch interaction as indicative of the particular physical tool based at least in part on the touch interaction being classified as any of a plurality of different touch interactions for the user's hand(s) formed into shapes defined by grasps that are suitable for manipulating the particular physical tool, wherein the plurality of different touch interactions associated with different ways for manipulating the particular physical tool are all classified as indicative of the particular physical tool, wherein the classifying the touch interaction includes classifying the touch interaction based on the distinguishing between the first touch interaction and the second touch interaction, and wherein the first touch interaction and second touch interaction correspond to different virtual tools.

12. A device comprising:
a touch screen;
a touch analysis module coupled to a processor for distinguishing between a first touch interaction, which has a first touch contact pattern associated with a first set of at least three simultaneous touch contacts, and a second touch interaction, which has a second touch contact pattern associated with a second set of the at least three simultaneous touch contacts, based at least in part on at least one difference between at least one of position, shape, size, orientation, pressure, or contacting part(s) of a user's hand(s) of the first set of the at least three simultaneous touch contacts and the second set of the at least three simultaneous touch contacts, wherein the first touch interaction and the second touch interaction are characterized by contact between the user's hand(s) and the touch screen of the device while the user's hand(s) are empty but formed into a shape defined by a grasp that is suitable for manipulating a particular physical tool, and for classifying a touch interaction as indicative of the particular physical tool based at least in part on the touch interaction being classified as any of a plurality of different touch interactions for the user's hand(s) formed into shapes defined by grasps that are suitable for manipulating the particular physical tool, wherein the plurality of different touch interactions associated with different ways for manipulating the particular physical tool are all classified as indicative of the particular physical tool, wherein the classifying the touch interaction includes classifying the touch interaction based on the distinguishing between the first touch interaction and the second touch interaction, and wherein the first touch interaction and second touch interaction correspond to different virtual tools.

13. The device of claim 12, wherein the processor is configured to, in response to classifying the touch interaction as indicative of the particular physical tool, instantiating, by the device, a virtual tool corresponding to the particular physical tool, wherein the virtual tool controls an action on the device that is similar to an action that can be performed by the particular physical tool and instantiating the virtual tool includes displaying a representation of the virtual tool at a location on the touch screen such that it appears the user is grasping the virtual tool.

14. The device of claim 13, wherein the touch screen is coupled to detection circuitry configured to detect the touch interaction characterized by a touch contact pattern including at least three simultaneous touch contacts on the touch screen by the user's hand(s) while the user's hand(s) are empty but formed into a shape defined by a grasp that is suitable for manipulating a particular physical tool.

15. The device of claim 14, wherein the detection circuitry is further configured to detect another touch interaction, and wherein the processor is further configured to cause the device to perform another action on a second device comprising a processor and communicatively coupled to the device.

16. The device of claim 15, wherein the detection circuitry is further configured to detect motion associated with the another touch interaction, and wherein the processor is further configured to adjust the representation of the virtual tool based at least in part on the detecting the motion and cause the another action to be performed on the second device.

17. The device of claim 14, wherein the detection circuitry is further configured to detect an additional user action made by the user, and wherein the processor is further configured to perform the action on the device based at least in part on the additional user action.

18. The device of claim 14, wherein the representation of the virtual tool comprises an image associated with the particular physical tool.

19. The device of claim 18, wherein the image associated with the particular physical tool is associated with at least one of a dial, a mouse, a wheel, a turn knob, or a slider control.

20. The device of claim 12, wherein the touch analysis module is further configured to determine the at least one of position, shape, size, orientation, pressure, or contacting part(s) of the user's hand(s) of the first set of the at least three simultaneous touch contacts.

21. The device of claim 20, wherein the touch analysis module is further configured to determine the at least one of position, shape, size, orientation, pressure, or contacting part(s) of the user's hand(s) of the first set of the at least three simultaneous touch contacts based at least in part on at least one of a number of touch points, an estimated total touch area, or magnitude of principle components of a point cloud associated with the at least three simultaneous touch contacts.

22. The device of claim 20, wherein the touch analysis module is further configured to determine the at least one of position, shape, size, orientation, pressure, or contacting part(s) of the user's hand(s) of the first set of the at least three simultaneous touch contacts based at least in part on at least one statistical quantity associated with at least one of a distance between a pair of points associated with the at least three simultaneous touch contacts, another distance between respective points associated with the at least three simultaneous touch contacts and the point cloud, respective angles between adjacent points associated with the at least three simultaneous touch contacts, or at least one feature associated with an ellipse fitted to the estimated total touch area, wherein the at least one statistical quantity comprises at least one of a mean, a median, a minimum, a maximum, or a standard deviation, and wherein the at least one feature associated with the ellipse fitted to the estimated total touch area comprises at least one of a major axis length, a minor axis length, an eccentricity value, or an area value determined for the ellipse.

23. The device of claim 12, wherein the device comprises at least one of a phone with the touch screen, a tablet computer with the touch screen, a computer with the touch screen, or an embedded control panel associated with the processor.

24. A device comprising:
a touch screen;
means for distinguishing between a first touch interaction, which has a first touch contact pattern associated with a first set of at least three simultaneous touch contacts, and a second touch interaction, which has a second touch contact pattern associated with a second set of the at least three simultaneous touch contacts, based at least in part on at least one difference between at least one of position, shape, size, orientation, pressure, or contacting part(s) of a user's hand(s) of the first set of the at least three simultaneous touch contacts and the second set of the at least three simultaneous touch contacts, wherein the first touch interaction and the second touch interaction are characterized by contact between the user's hand(s) and a touch screen of the device while the user's hand(s) are empty but formed into a shape defined by a grasp that is suitable for manipulating a particular physical tool; and
means for classifying a touch interaction as indicative of the particular physical tool based at least in part on the touch interaction being classified as any of a plurality of different touch interactions for the user's hand(s) formed into shapes defined by grasps that are suitable for manipulating the particular physical tool, wherein the plurality of different touch interactions associated with different ways for manipulating the particular physical tool are all classified as indicative of the particular physical tool, wherein the classifying the touch interaction includes classifying the touch interaction based on the distinguishing between the first touch interaction and the second touch interaction, and wherein the first touch interaction and second touch interaction correspond to different virtual tools.

25. The device of claim 24, further comprising at least one of:
means for, in response to classifying the touch interaction as indicative of the particular physical tool, instantiating, by the device, a virtual tool corresponding to the particular physical tool, wherein the virtual tool controls an action on the device that is similar to an action that can be performed by the particular physical tool and instantiating the virtual tool includes displaying a representation of the virtual tool at a location on the touch screen such that it appears the user is grasping the virtual tool; or
means for detecting the touch interaction characterized by a touch contact pattern including at least three simultaneous touch contacts on the touch screen by the user's hand(s) while the user's hand(s) are empty but formed into a shape defined by a grasp that is suitable for manipulating a particular physical tool.
